(19) United States
(12) Patent Application Publication
(10) Pub. No.: US 2007/0255512 A1
(43) Pub. Date: Nov. 1, 2007

(54) Methods and systems for facilitating analysis of feature extraction outputs

(76) Inventors: Glenda C. Delenstarr, Redwood City, CA (US); Charles D. Troup, Livermore, CA (US); John F. Corson, Mountain View, CA (US); Andrew Payne, Lincoln, MA (US); David Benjamin Gordon, Somerville, MA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/413,643

(22) Filed: Apr. 28, 2006

(51) Int. Cl. G06F 19/00; G06F 17/40

(52) U.S. Cl. 702/35; 702/127; 702/187; 702/179; 702/180; 702/183; 702/1; 702/189

(57) ABSTRACT

Methods, systems and computer readable media for facilitating analysis of feature extraction outputs across multiple extractions. A feature extraction output of an extraction resulting from feature extraction of an array is inputted, and global statistics and array processing parameters are extracted from the feature extraction output. A table/file is populated with the extracted global statistics and array processing parameters of the extraction. The inputting, extracting and populating steps are repeated for at least one additional feature extraction output of another extraction, so that the table/file includes global statistics that can be readily cross-compared over multiple extractions with reference to a single table or file. Methods, systems and computer readable media are provided for setting threshold values for metrics that global statistics are provided for. An evaluation metric may be set by a user, based upon the threshold values set for the metrics. A metric set including the metrics and optionally one or more thresholds and optionally an evaluation metric may be stored and/or applied to additional global statistics for those metrics to evaluate the quality of one or more extractions. A set of reports are provided for facilitating analysis of feature extraction outputs across multiple extractions. A diagnostic tool is provided for identifying and diagnosing potential problems in feature extraction outputs.

### BACKGROUND OF THE INVENTION

Users of chemical arrays such as nucleic acid microarrays, CGH arrays, arrays measuring protein abundance and the like need software packages to perform feature extraction, that is, to extract signal and/or log ratio data from the features on the arrays. Chemical array data may have flaws due to problems in “upstream” processes such as: array synthesis; target preparation (“prep”)/labeling; hybridization (“hyb”)/wash; scanning; and the feature extraction algorithms used to process the data. Often the data produced is used without any quality control (QC) of such flaws by the user or the software.

Users may visually check an array to see if there are obvious flaws (e.g. streaks due to hyb/wash problems; incorrect feature positioning by the feature extraction software; etc). However, this is a very time-consuming and subjective process, not lending itself to production of metrics that can be tracked over time.

Some currently available software may report QC metrics such as overall signal level or average signal and standard deviation of signal of specific probes. However, these metrics may not cover the entire range of problems that may occur and make trouble-shooting difficult as to which upstream process may be flawed. Currently available QC software may not account for internal details of the processes to which arrays are subjected, e.g., such as array design, probe synthesis, target prep/labeling, array hyb/wash/scan and/or feature extraction. Different error modes may occur depending upon the type of processes used upstream of the data analysis step(s).

Users may have preferences to see certain metrics and not others, depending upon their experiments. Metrics may be reported without threshold warnings. Users often desire performance metrics such as “sensitivity”, “dynamic range”, “linearity” etc. A problem with these terms is that they can be can be defined in many different manners causing a lack of standardization across platforms and/or experiments. Additionally, these definitions may not be appropriate for all array experimental conditions.

Users may have difficulties in interpreting array data due to incorrect algorithms being used (e.g. background-subtraction, dye-normalization algorithms and the like) and not have metrics that readily aid in this type of evaluation.

Co-pending, commonly owned application Ser. No. 11/192,680 filed Jul. 29, 2005 and titled “System and Methods for Characterization of Chemical Arrays for Quality Control” provides, inter alia, a QC report that is typically a two-three page report that summarizes a subset of global statistics calculated from the extraction of features on an array. Application Ser. No. 11/192,680 is hereby incorporated herein, in its entirety, by reference thereto. The QC report may contain global statistics in text format, as well as graphical representations of selected statistical values for all or a subset of features on the array. While the QC report is effective in condensing the available statistical measures and feature signal value readings contained in the overall feature extraction results and provides graphical visualization of some statistics, a user still needs to review a QC report for each array extracted, which may be time consuming and tedious when running a batch of arrays for feature extraction.

For example, a user may have ninety-nine arrays used to conduct an experiment. These arrays may be efficiently feature extracted in a batch mode using currently available feature extraction systems, such as Agilent's Feature Extraction software (Agilent Technologies, Inc., Palo Alto Calif.) or other packages that are available on the market. Even when the QC report described in application Ser. No. 11/192,680 is provided, the user would still be required to review two-three pages of summary statistics and graphical representations for each extraction, that is 2-3 pages times 99, which can be quite time consuming and tedious. The review is also subjective, as the user has no easy way to objectively compare the results between QC reports. Thus, users need to develop thresholds or ranges for these statistics in their own databases, which may be variable among user to user or group to group and thus results of analysis of the same data can be very inconsistent among different groups/individuals.

There remains a need for quality control solutions for objectively determining the quality of chemical arrays including sets of arrays that may cover a variety of different experiments and different experimental conditions employed, and solutions that facilitate more efficient comparison of extraction results and extraction quality between arrays, as well as more efficient solutions for inspecting the quality of extractions performed in batch mode.

### SUMMARY OF THE INVENTION

Methods, systems and computer readable media for facilitating analysis of feature extraction outputs across multiple extractions. A feature extraction output of an extraction resulting from feature extraction of an array is inputted, and global statistics and array processing parameters are extracted from the feature extraction output. A table/file is populated with the extracted global statistics and array processing parameters of the extraction. The inputting, extracting and populating steps are repeated for at least one additional feature extraction output of another extraction, so that the table/file includes global statistics that can be readily cross-compared over multiple extractions with reference to a single table or file.

One or more charts of one or more metrics may be plotted for extractions in the table/or file for those metrics. Charts may be displayed on a user interface for review by a user.

Methods, systems and computer readable media are provided for querying a file containing global statistics and array processing parameters for each of a plurality of extractions to select a subset of records, each record containing global statistics and array processing parameters for a different extraction. A metric may be selected for which metrics from the global statistics are reported in the subset of the extractions, from which a chart is plotted of the metric values in the subset of extractions reported for the metric. Statistics may be calculated to characterize the distribution of the plotted metric values, and a threshold value may be set for the distribution.

Additional thresholds may be set similarly for different metrics.

An evaluation metric may be user set, based upon the thresholds set for a plurality of metrics.

The metrics, thresholds, evaluation metric and queries used to obtain the extraction sets from which the metrics were selected may be used as a metric set to evaluate other extractions, and/or stored in a database for future use.

A set of reports are provided for facilitating analysis of feature extraction outputs across multiple extractions, including a statistics table containing global statistics for metrics, array processing parameters and user annotations for multiple extractions, each row of the table containing data for a single extraction, the data including at least global statistics and an array processing parameter, including a unique identifier for the extraction, wherein the table contains data for at least two different extractions; and a QC chart displaying at least one plot of metric values versus a plurality of the extractions.

A retrospective system for facilitating analysis of feature extraction outputs across multiple extractions is provided to include a processor; and a retrospective tool programmed to receive an input of a feature extraction output of an extraction resulting from feature extraction of an array, extract global statistics and array processing parameters from the feature extraction output, and populate a table or file with the extracted global statistics and array processing parameters of the extraction.

A diagnostic tool is provided for identifying and diagnosing potential problems in feature extraction outputs, including: a processor; a set of diagnostic rules; a rules software language executable by the processor to execute the rules against at least one of feature extraction global statistics and feature extraction data, to determine whether logic provided in a rule is met or violated by the global statistic or feature data value compared; and programming for outputting potential problems identified by executing the rules against the data value.

A method of evaluating the quality of feature extraction outputs from a plurality of arrays expected to produce the same results is provided, including: inputting feature extraction outputs of the extractions resulting from feature extraction of the arrays; extracting global statistics and array processing parameters from the feature extraction outputs; populating a table or file with the extracted global statistics and array processing parameters of the extractions; plotting at least one metric from global statistics reported for that metric for the extractions; and analyzing the at least one plot to identify potential outliers.

A method of correlating a change in an array processing parameter for an extraction with changes in feature extraction outputs is provided, including: inputting feature extraction outputs of extractions resulting from feature extraction of arrays having a first set of array processing parameters; extracting global statistics and array processing parameters from the feature extraction outputs; inputting array processing parameters, outputs of extractions resulting from feature extraction of arrays having a second set of array processing parameters, wherein the second set is the same as the first set except for a change in one or a small percentage of the array processing parameters; extracting global statistics and array processing parameters from the feature extraction outputs from the arrays having the second set of array processing parameters; populating a table or file with all extracted global statistics and array processing parameters of the extractions; plotting at least one metric from the global statistics reported for that metric for the extractions; and comparing the values in the at least one plot to establish whether there is a significant difference between metric values from the arrays having the first set of array processing parameters versus metric values from the arrays having the second set of array processing parameters.

A method of developing a microarray product is provided, including: inputting feature extraction output of an extraction resulting from feature extraction of an existing array; extracting global statistics and array processing parameters from the feature extraction output; inputting feature extraction output of an extraction resulting from feature extraction of an array similar to the existing array, but in which at least one factor was changed; extracting global statistics and array processing parameters from the feature extraction output from the array similar to the existing array; populating a table or file with all extracted global statistics and array processing parameters of the extractions; plotting at least one metric from the global statistics reported for that metric for the extractions; and comparing the values in the at least one plot to establish whether the change of at least one factor had a positive, negative, or no impact on the feature extraction output as measured by the at least one metric.

A method of diagnosis of potential errors in feature extraction outputs is provided, including: inputting a feature extraction output of an extraction resulting from feature extraction of an array; extracting global statistics and array processing parameters from the feature extraction output; populating a table or file with the extracted global statistics and array processing parameters of the extraction; and repeating the steps of inputting, extracting and populating for at least one additional feature extraction output of another extraction, so that the table or file includes global statistics that can be readily cross-compared over multiple extractions with reference to a single table or file; plotting a chart of metric values for a metric in the table or file for a plurality of extractions; evaluating the values in the chart to identify potential outliers; and correlating one or more array processing parameters that are different between two sets of the metric values, one set predominantly containing the potential outliers and the other set containing predominantly non-outlier values; and identifying the one or more array processing parameters as possibly causative of the potential errors.

A method of diagnosis of potential errors in feature extraction outputs is provided, including executing a set of diagnostic rules against a global statistic or feature data value to determine whether the value complies with logic contained with the set of rules; and outputting a warning and diagnosis of a potential error for an extraction when a rule is found to have been violated by not complying with the logic contained in a rule.

Methods, systems and computer readable media are provided to store global statistics array processing parameters and user annotations in association with extractions that they characterize, in a database that may be integrated with a feature extraction system.

Methods, systems and computer readable media are provide to facilitate customized viewing of metrics to assist in threshold setting. Included are features that facilitate customized ordering and/or grouping of extractions to assist a user in viewing charts of global statistics plotted against metrics that measure the extraction data.

The present invention provides a consistent objective manner in which to evaluate metrics to produce thresholds by permitting a user to customize queries and save those queries.

The system generates and stores a threshold file that may be used by a feature extraction tool to evaluate metrics and evaluate overall array quality.

### BRIEF DESCRIPTION OF THE DRAWINGS

FIG. 1 shows an exemplary substrate carrying an array, such as may be feature extracted by a feature extraction system to provide feature extraction output data.

FIG. 2 shows an enlarged view of a portion of FIG. 1 showing spots or features.

FIG. 3 is a high level schematic representation of an embodiment of systems provided herein.

FIG. 4 illustrates a table of feature extractions outputs that include three sub-tables or groups of information.

FIG. 5 illustrates an example of a portion of a QC report.

FIG. 6 illustrates an example of a statistics table 210.

FIG. 6A shows a screen shot of a statistics table interface displayed on a user interface in preparation for generating a statistics table.

FIG. 6B shows a screen shot of a partial view of a statistics table after loading a first set of extractions and making initial extraction queries.

FIG. 6C shows a screen shot where the user has selected to recursively load extractions from a series of folders, by selecting the recursive import feature.

FIG. 6D shows a screen shot of a browser feature that may be provided in the statistics table interface to allow a user to select folders from which to import data from extractions into a statistics table.

FIG. 6E is a screen shot of a browse feature that may be provided in the statistics table interface to allow a user to select files from which to import user annotations into a statistics table.

FIG. 6F is a screen shot of an extraction query builder feature that may be provided in extraction query interface for interactive building of extraction queries.

FIG. 6G shows a screen shot of extractions displayed in a statistics table, with query interface overlaid to show an extraction query that a user desires to run on the statistics table.

FIG. 6H shows the results of running the extraction query in the example of FIG. 6G.

FIG. 7 illustrates an example of a QC chart displaying vertically stacked charts.

FIG. 8 illustrates components of one embodiment of a metric table set.

FIG. 9 illustrates an example of a Batch Run Summary (Project Run Summary) that may be outputted at the end of a batch feature extraction project.

FIG. 10 illustrates a QC chart displaying vertically stacked charts and a summary display showing the number of metrics that are within range for each extraction (optionally the total number of metrics may be displayed along side, for reference) adjacent each extraction identifier along the X-axis beneath the lowest-displayed chart.

FIG. 11 illustrates an example of a Summary Plot generated by a retrospective tool after evaluating five feature extraction results data files/reports generated by feature extracting a batch of five arrays/extractions.

FIG. 12A illustrates an embodiment of a chart in QC chart where the user has selected to user integer numbering to identify the extractions along the X-axis.

FIG. 12B shows an example of a QC chart interface that may be displayed in a user interface to set up a chart to be plotted in a QC chart in a manner desired by a user.

FIG. 12C shows the interface of FIG. 12B where another metric has been added to the selected metric set and color and shape settings have been selected by a user.

FIG. 12D shows the same charts as plotted in FIG. 12A, but where the inliers (as determined by threshold) have been interconnected by a first set of straight lines and the outliers have been connected by a second set of straight lines.

FIG. 13 illustrates an embodiment of a QC chart in which the user chose grouping or stacking of extractions displayed along the X-axis.

FIG. 14 illustrates an embodiment of a drop down list in a user interface from which a user may select which field in DataStore to use for ordering.

FIG. 15 illustrates an example of a chart plotted where particular statistics are plotted with particular icons or geometric shapes and/or particular color-coding.

FIG. 16 illustrates an example of a query table.

FIG. 17 shows a chart in which global statistics data from extractions are grouped by scan date and type/description (i.e., control or test) along the X-axis.

FIGS. 18A-18F illustrate interactive user features provided in one embodiment of a user interface for setting and creating metrics and thresholds.

FIG. 19 illustrates a plot of chart 252 of the same metric and data points shown in FIG. 15, and with an upper threshold limit 254 plotted, wherein the upper threshold limit was calculated from all data points except data point 252re in FIG. 15.

FIG. 20 illustrates a threshold evaluation box displaying threshold evaluation numbers, alongside chart 252.

FIG. 21 illustrates a flow of events that may be carried out according to one embodiment of use.

FIG. 22 illustrates events that may be carried out to perform tasks similar to those described with regard to FIG. 21, but where data from extractions that are stored in retrospective database are used in the process as obtained by querying database 100.

FIG. 23 illustrates events that may be carried out by a retrospective system, according to an embodiment described herein, when used for setting thresholds.

FIGS. 24A-24B illustrate a chart 252 before and after sorting or re-querying to rearrange the order of the plotted data points in a diagnosis or trouble-shooting embodiment of use.

FIG. 25 illustrates elements that may be included in a diagnostic rule.

FIG. 26 illustrates a report showing severity levels that may be reported as a result of a diagnostic procedure described herein.

FIG. 27 illustrates a batch summary of diagnostic results.

FIG. 28 is a diagram of a central rules database (rules server) that may be accessed by multiple diagnosis tools.

FIGS. 29A-29E illustrate tables employed by a database schema for a retrospective database according to an embodiment of the invention.

FIG. 30 illustrates a table showing fields that may be stored when storing a query according to an embodiment of the invention.

FIG. 31 is a schematic illustration of a typical computer system that may be used to perform procedures described herein.

### DETAILED DESCRIPTION OF THE INVENTION

Before the present methods, tools, systems, software and hardware are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “an extraction” includes a plurality of such extractions and reference to “the array” includes reference to one or more arrays and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

A “chemical array”, “microarray”, “bioarray” or “array”, unless a contrary intention appears, includes any one-, two- or three-dimensional arrangement of addressable regions bearing a particular chemical moiety or moieties associated with that region. A microarray is “addressable” in that it has multiple regions of moieties such that a region at a particular predetermined location on the microarray will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. Nos. 6,242,266; 6,232,072; 6,180,351; 6,171,797 and 6,323,043. As already mentioned these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. Scanning typically produces a scanned image of the array which may be directly inputted to a feature extraction system for direct processing and/or saved in a computer storage device for subsequent processing. However, arrays may be read by any other methods or apparatus than the foregoing, other reading methods including other optical techniques or electrical techniques (where each feature is provided with an electrode to detect bonding at that feature in a manner disclosed in U.S. Pat. Nos. 6,251,685, 6,221,583 and elsewhere).

An array is “addressable” when it has multiple regions of different moieties, i.e., features (e.g., each made up of different oligonucleotide sequences) such that a region (i.e., a “feature” or “spot” of the array) at a particular predetermined location (i.e., an “address”) on the array will detect a particular solution phase nucleic acid sequence. Array features are typically, but need not be, separated by intervening spaces.

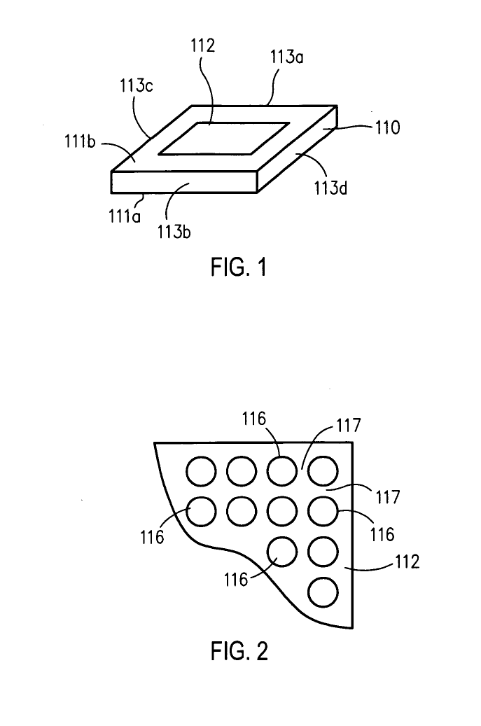

An exemplary array is shown in FIGS. 1-2, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the surface 111b adjacent the opposed sides 113c, 113d and leading end 113a and trailing end 113b of slide 110, not being covered by any array 112. A surface 111a of the slide 110 typically does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of oligomers, e.g., in the form of polynucleotides, and specifically oligonucleotides. As mentioned above, all of the features 116 may be different, or some or all could be the same. The interfeature areas 117 could be of various sizes and configurations. Each feature carries a predetermined oligomer such as a predetermined polynucleotide (which includes the possibility of mixtures of polynucleotides). It will be understood that there may be a linker molecule (not shown) of any known types between the surface 111b and the first nucleotide.

Substrate 110 may carry on surface 111a, an identification code, e.g., in the form of bar code (not shown) or the like printed on a substrate in the form of a paper or plastic label attached by adhesive or any convenient means. The identification code contains information relating to array 112, where such information may include, but is not limited to, an identification of array 112, i.e., layout information relating to the array(s), etc.

In the case of an array in the context of the present application, the “target” may be referenced as a moiety in a mobile phase (typically fluid), to be detected by “probes” which are bound to the substrate at the various regions.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

A “design file” is typically provided by an array manufacturer and is a file that embodies all the information that the array designer from the array manufacturer considered to be pertinent to array interpretation. For example, Agilent Technologies supplies its array users with a design file written in the XML language that describes the geometry as well as the biological content of a particular array.

A “grid template” or “design pattern” is a description of relative placement of features, with annotation. A grid template or design pattern can be generated from parsing a design file and can be saved/stored on a computer storage device. A grid template has basic grid information from the design file that it was generated from, which information may include, for example, the number of rows in the array from which the grid template was generated, the number of columns in the array from which the grid template was generated, column spacings, subgrid row and column numbers, if applicable, spacings between subgrids, number of arrays/hybridizations on a slide, etc. An alternative way of creating a grid template is by using an interactive grid mode provided by the system, which also provides the ability to add further information, for example, such as subgrid relative spacings, rotation and skew information, etc.

A “grid file” contains even more information than a “grid template”, and is individualized to a particular image or group of images. A grid file can be more useful than a grid template in the context of images with feature locations that are not characterized sufficiently by a more general grid template description. A grid file may be automatically generated by placing a grid template on the corresponding image, and/or with manual input/assistance from a user. One main difference between a grid template and a grid file is that the grid file specifies an absolute origin of a main grid and rotation and skew information characterizing the same. The information provided by these additional specifications can be useful for a group of slides that have been similarly printed with at least one characteristic that is out of the ordinary or not normal, for example. In comparison when a grid template is placed or overlaid on a particular microarray image, a placing algorithm of the system finds the origin of the main grid of the image and also its rotation and skew. A grid file may contain subgrid relative positions and their rotations and skews. The grid file may even contain the individual spot centroids and even spot/feature sizes. Further information regarding design files, grid templates, design templates and grid files and their use can be found in U.S. Patent Publication No. US 2006/0064246 titled “Automated Processing of Chemical Arrays and Systems Therefore. U.S. Patent Publication No. US 2006/0064246 is hereby incorporated herein, in its entirety, by reference thereto.

A “history” or “project history” file is a file that specifies all the settings used for a project that has been run, e.g., extraction names, images, grid templates protocols, etc. The history file may be automatically saved by the system and, in one aspect, is not modifiable. The history file can be employed by a user to easily track the settings of a previous batch run, and to run the same project again, if desired, or to start with the project settings and modify them somewhat through user input. History files can be saved in a database for future reference.

“Image processing” refers to processing of an electronic image file representing a slide containing at least one array, which is typically, but not necessarily in TIFF format, wherein processing is carried out to find a grid that fits the features of the array, e.g., to find individual spot/feature centroids, spot/feature radii, etc. Image processing may even include processing signals from the located features to determine mean or median signals from each feature and may further include associated statistical processing. At the end of an image processing step, a user has all the information that can be gathered from the image.

“Post processing” or “post processing/data analysis”, sometimes just referred to as “data analysis” refers to processing signals from the located features, obtained from the image processing, to extract more information about each feature. Post processing may include but is not limited to various background level subtraction algorithms, dye normalization processing, finding ratios, and other processes known in the art.

“Feature extraction” includes image processing and post processing. An extraction refers to the information gained from image processing and post processing a single array. Feature extraction may include, but is not limited to: image extraction, signal intensity extraction, analysis of features and background regions of the image and signals extracted therefrom, post-processing such as ChIP-Chip analysis and other tiling analysis, CGH analysis (e.g., such as performed by CGH Analytics, Agilent Technologies, Inc., Palo Alto, Calif.) and other post processing techniques currently practiced in the field.

“Array processing parameters” refer to inputs to a feature extraction system that are used to feature extract an array or a batch of arrays. Further, a batch of arrays may be processed in batch mode wherein different arrays within the batch are assigned different array processing parameters. Still further, the same array may be processed multiple times with different assignment of array processing parameters and/or different arrays may be processed with the same array processing parameters in a batch process. Examples of array processing parameters include, but are not limited to: scan date, type of scanner used, version of scanning software used, dye normalization algorithm used, background subtraction algorithm used and user's name that is performing the extraction, grid file, and version of the feature extraction software that is being used on the array to be processed.

A “protocol” or “feature extraction (FE) protocol” provides feature extraction parameters for algorithms (which may include image processing algorithms and/or post processing algorithms to be performed at a later stage or even by a different application) for carrying out feature extraction and interpretation of data from an image that the protocol is associated with. Thus, feature extraction protocols are a subset of array processing parameters. A protocol may also have user preferences regarding a QC Report which may be used as a summary of overall metrics measured and/or calculated, or a subset of metrics. Such preferences may specify which metrics are reported in the QC Report, for example, type of metrics, specific metrics to report, or specify that only metrics that pass or fail some user-defined threshold are reported. Other preferences may specify which type of QC Report is to be produced, for example, a two-channel (two-color) or single channel (single color) report. Additionally, specified types may include Gene Expression, CGH, Location Analysis (also know as ChIP-Chip analysis), etc. Protocols are user definable and may be saved/stored on a computer storage device, thus providing users flexibility in regard to assigning/pre-assigning protocols to specific microarrays and/or to specific types of microarrays. The system may use protocols provided by a manufacturer(s) for extracting arrays prepared according to recommended practices, as well as user-definable and savable protocols to process a single microarray or to process multiple microarrays on a global basis, leading to reduced user error. The system may maintain a plurality of protocols (in a database or other computer storage facility or device) that describe and parameterize different processes that the system may perform. The system also allows users to import and/or export a protocol to or from its database or other designated storage area.

An “array set” refers to a plurality of arrays that are designed, hybridized and analyzed together to form a single virtual array. Tiling applications, such as ChIP-Chip analyses, for example, are often performed using array sets. For example, a virtual array image of 440,000 features can be analyzed, feature extracted etc., by forming an array set from ten arrays each having 44,000 features.

A statistic is a numerical measurement or estimated (calculated) measurement of a characteristic of a signal received from scanning an array. Thus, a statistic is a numerical score that quantifies some aspect of a feature/features signal. For example, a mean intensity value of a feature is a statistic, as is a standard deviation value for pixel intensity within a feature.

A “global statistic” refers to a statistic that takes into consideration all features on an array for a stated statistic (or a subset of features or local background regions that pertains to the stated statistic). For example, global statistics include, but are not limited to: an average signal value of all negative control features on an array, the total number of outliers found on an array, the total number of saturated features found on an array, the average background signal over an array, the total number of non-uniform features on an array, etc. In one implementation, global statistics may be calculated by a feature extraction tool as described herein and presented in the feature extraction output.

A “summary statistic” is a statistic computed for a global statistic or user defined metric across a plurality of extractions.

A “metric” is a characteristic of a feature, set of features, or set of local background regions to be measured. A metric can be based upon a single global statistic, a derivative of a global statistic (e.g., the absolute value of a global statistic), a derivative of several global statistics (e.g., %Features_GreenNonUnifOlr (percentage of features in the green channel that are non-uniform)=100*NumberFeat_gNonUnif/TotalNumFeat (one hundred times the ratio of the total number of non-uniform green features to the total number of (green) features), one or more user annotations, or any combination of these.

A “metric set” includes one or more metrics, and may have associated thresholds, an evaluation metric and/or a reference to the extraction query which produced the threshold values.

An “evaluation metric” is a rule that when applied determines whether an extraction has passed the rule or needs to be evaluated by a user. The evaluation metric may be set by the user based upon results of metrics in a metric set that are applied to the extraction to evaluate it.

A “statistics table” refers to a file which may be created by a statistics tool described herein. The statistics table includes names/identifiers of extractions and global statistics that have been calculated for those extractions. The statistic table incorporates a plurality of extractions and global statistics from a plurality of feature extraction output files into a single table to facilitate comparisons of results across different extractions.

An “extraction query” is a query by which the retrospective tool selects the desired set of extractions to use in a statistics table or QC chart.

“User annotations” refer to additional annotations that may be appended to extraction data stored in a statistics table, according to techniques provided herein. User annotations include, project name, laboratory name, department name, different dates that may be important to the experimental outcome, identification of the red sample used, identification of the green sample used, analytic information concerning quality of samples used, buffers used in the experiment conducted on the array, or any other annotation that a user may believe is useful in identifying and differentiating or grouping the data in a particular extraction from or with other extractions. User annotations are completely flexible, so the user can literally input any information as a user annotation.

A “feature extraction project” or “project” refers to a smart container that includes one or more extractions that may be processed automatically, one-by-one, in a batch. An extraction is the unit of work operated on by the batch processor. Each extraction includes the information that the system needs to process the slide (scanned image) associated with that extraction.

When one item is indicated as being “remote” from another, this is referenced that the two items are not at the same physical location, e.g., the items are at least in different rooms or buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

A “database” refers to any ordered collection of records stored on a computer readable medium such that the records may be accessed and inputted to a processor for processing. A database may take the form of a commercial database, such as an SQL database, for example, or may be stored as a file or other data structure.

Reference to a singular item, includes the possibility that there are plural of the same items present.

“May” means optionally.

Methods recited herein may be carried out in any order of the recited events which is logically possible, as well as the recited order of events.

All patents and other references cited in this application, are incorporated into this application by reference except insofar as they may conflict with those of the present application (in which case the present application prevails).

Systems and Methods

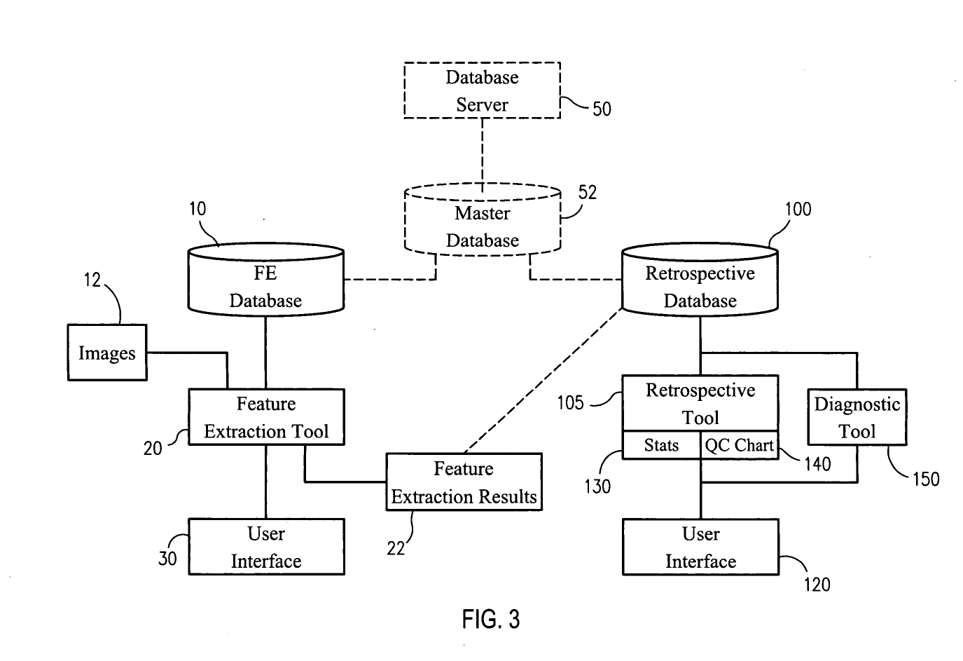

Referring now to FIG. 3, a high level schematic representation of an embodiment of systems provided herein is illustrated. A retrospective database 100 is provided for storing global statistics, user/experimental annotations, array processing parameters, threshold files, queries and metric sets. A statistics table (e.g., in a spreadsheet format) may be generated and displayed to view the user/experimental annotations, array processing parameters and global statistics for the extractions stored in retrospective database or for a subset of those extractions.

Feature Extraction (FE) database 10 stores grid files and protocols. A grid file may be associated with an array to be extracted and, when inputted to feature extraction tool, tells the feature extraction software what the relative placement of features on the array is, basic grid information from the design file that it was generated from, which information may include, for example, the number of rows in the array from which the grid template was generated, the number of columns in the array from which the grid template was generated, column spacings, subgrid row and column numbers, if applicable, spacings between subgrids, number of arrays/hybridizations on a slide, etc. Further information, such as subgrid relative spacings, rotation and skew information may be provided. An absolute origin of a main grid and rotation and skew information characterizing the same may also be provided. The grid file may even contain the individual spot centroids and even spot/feature sizes, types of features (e.g., experimental, negative control, positive control, etc.) and identification of sequences that are present on each feature. Typically, there may be hundreds of grid files stored in feature extraction database 10, although database 10 may store more or fewer grid files, which may depend upon a user's (or group of user's) needs.

A protocol specifies the various algorithms that the feature extraction tool 20 will use during the feature extraction of an array. Each stored protocol varies from the others in the combination of algorithms identified to be used.

Thus, an array may be extracted according using various different algorithms (e.g., for background subtraction, dye normalization, one or two channel processing, 22,000 feature array, 44,000 feature array, low stringency, high stringency, etc.) depending upon the protocol assigned to it for the feature extraction to be performed.

Electronic images 12 of arrays (such as images produced by scanning arrays, as described above) are inputted to a feature extraction tool 20 along with parameters for perform the feature extraction of the arrays, including grid files, protocols and other parameters that may be included with the images. The feature extraction system is typically integrated into a computer system that includes one or more user interfaces 30 for a user to interactively set up and run feature extractions.

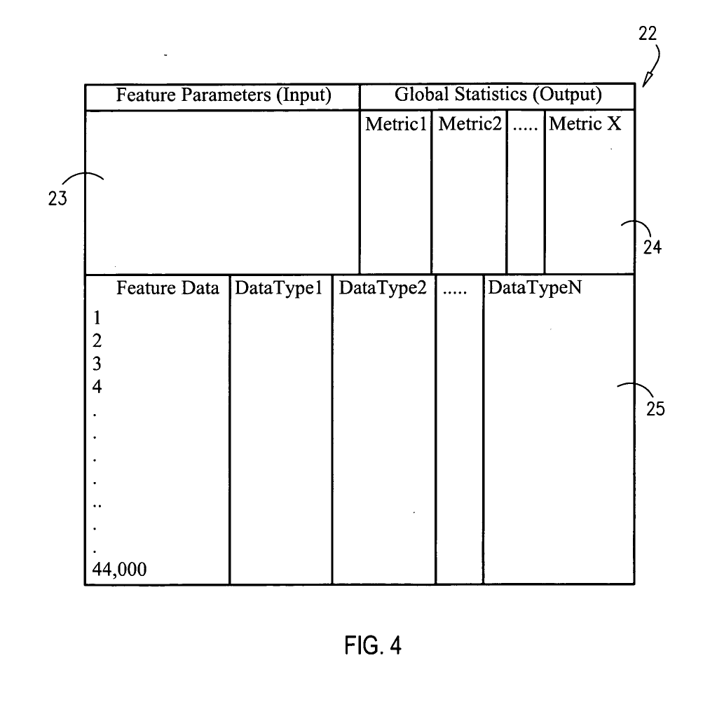

A typical output 22 from the feature extraction tool 20 (i.e., an “extraction”) generally includes three tables or groups of information, see FIG. 4. The first group of information or table 23 lists the array processing parameters that were inputted to feature extraction tool 20 and which were used in performing the extraction. The second table or group of information 24 lists the global statistics that were calculated for the array by the feature extraction tool. There are many global statistics, in the tens and possibly over a hundred, examples of which include, but are not limited to: the number of saturated features in the green channel (gNumSatFeat), the number of saturated features in the red channel (rNumSatFeat), the average intensity of the local background inliers, red channel (rlocalBGInlierAve), the average intensity of the local background inliers, green channel (glocalBGlnlierAve), the number of feature non-uniform outliers in the green channel (gNumFeatureNonUnifOL), the number of feature non-uniform outliers in the red channel (rNumFeatureNonUnifOL), the linear dye normalization factor for the red channel (rLinearDyeNormFactor), the linear dye normalization factor for the green channel (gLinearDyeNormFactor), the 50^{th} percentile of the net signals of non-control features, green channel (gNonCtrl50PrcenNetSig), the 50^{th} percentile of the net signals of non-control features, red channel (rNonCtrl50PrcenNetSig), the average background-subtracted signal of negative control features, red channel (rNegCtrIAveBGSubSig), the average background-subtracted signal of negative control features, green channel (gNegCtrIAveBGSubSig), the standard deviation of the background-subtracted signals of negative control features, red channel (rNegCtrlSDevBGSubSig), the standard deviation of the background-subtracted signals of negative control features, green channel (gNegCtrlSDevBGSubSig), the log ratio of the signal to noise ratio of the non-control features (NonCtrlSNRLogRatio), the number of up-regulated non-control features (NonCtrlNumUpReg), the number of down-regulated non-control features (NonCtrlNumDownReg), the 50^{th} percentile of the background-subtracted signals of the non-control features, green channel (gNonCtrl50PrcntBGSubSig), and the 50^{th} percentile of the background-subtracted signals of the non-control features, red channel (rNonCtrl50PrcntBGSubSig).

The third table or group of information 25 is a listing of feature data for each feature on the array. Feature data include various signal measurements that feature extraction tool measured from each feature and may include, but are not limited to: feature number (FeatNum), X position of the feature on an X-Y grid that maps the array (PositionX), Y position of the feature on the X-Y grid (PositionY), log ratio of the red to the green signals from the feature (LogRatio), error associated with the LogRatio measurement (LogRatioError), mean signal from the pixels for the feature, green channel (gMeanSignal), mean signal from the pixels for the feature, red channel (rMeanSignal), median signal from the pixels for the feature, green channel (gMedianSignal), median signal from the pixels for the feature, red channel (rMedianSignal), standard deviation of the pixel signals for the feature, red channel (rPixSDev), standard deviation of the pixel signals for the feature, green channel (gPixSDev), an indication of whether the feature is saturated, green channel (gIsSaturated), an indication of whether the feature is saturated, red channel (rIsSaturated), an indication of whether the feature was determined to be a non-uniform outlier, red channel (rIsFeatNonUnifOL), an indication of whether the feature was determined to be a non-uniform outlier, green channel (glsFeatNonUnifOL), background-subtracted signal, red channel (rBGSubSignal), background-subtracted signal, green channel (gBGSubSignal), dye-normalized signal, red channel (rDyeNormSignal), and dye-normalized signal, green channel (gDyeNormSignal).

As feature data is listed for each feature on an array, this table can be quite lengthy and onerous to review. For example, an array may have in the neighborhood of 44,000 or more features, or 244,000 or more, or 1,000,000 or more, so there will be a row of feature data presented in table 25 for each of those 44,000 or more features (or at least the majority of the features if a few are unreadable, but then the unreadable ones may be reported as such with one or more feature data categories). Each row of feature data contains multiple data entries, typically in the range of about ten to about one hundred different types of feature data entries.

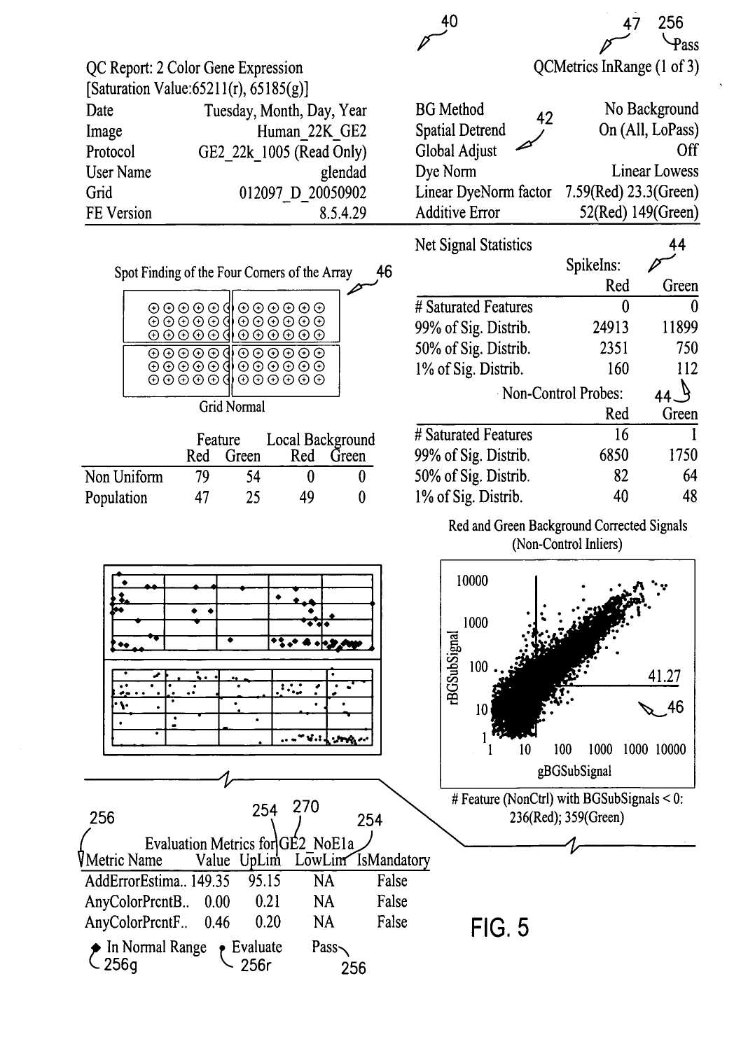

Similarly, it is not unusual to have about ten to about one hundred twenty different metrics, each of which feature extraction tool 20 calculates a global statistic for and reports them in the global statistics section 24. Because it is often time consuming and tedious for a user to attempt to interpret all of the data and statistics presented in a feature extraction output 22, co-pending, commonly owned application Ser. No. 11/192,680 creates a QC report that is typically a two-four page report that summarizes a subset of global statistics calculated from the extraction of features on an array. FIG. 5 illustrates an example of a portion of a QC report 40, including part of the first page and part of the last page. Array processing parameters, including protocol may be extracted from the feature extraction output 22 and reported in section 42 of QC report 40. An evaluation metric 47 is also reported at the top indicating that one out of the three metrics applied in a metric set were within range. Evaluation metrics and metric sets are discussed in further detail below. QC report 40 reports a subset of the total number of metrics/global statistics contained in feature extraction output 22. The global statistics 44 are in text format. QC report typically also includes graphical representations 46 of selected statistical values for all or a subset of features on the array. While the QC report 40 is effective in condensing the available statistical measures and feature signal value readings contained in the overall feature extraction results 22 and provides graphical visualization of some statistics, a user still needs to review a QC report 40 for each array extracted, which may be time consuming and tedious when running a batch of arrays for feature extraction. Further, each QC report 40 still contains a fairly large number of global statistics. Although a subset of the total number of metrics/global statistics reported in the feature extraction output 22, it is not unusual for the number of metrics/global statistics 44 reported in QC report 40 to be ten or more. This presents a complex, multi-variate exercise to the user when a user wishes to compare results across multiple extractions/arrays. For example, if a user has run an experiment using ninety-nine arrays and there are ten global statistics reported for each extraction in each QC report, the user needs to compare and contrast ten global statistics across ninety-nine QC reports (extractions). This is very difficult, tedious and time consuming to do manually on a spreadsheet. Such an approach is also prone to error, and different results are likely among different users attempting a comparison in this way.

The present invention provides a retrospective tool 105 and system that is configured to present global statistics in ways that are easily used to facilitate comparisons of extraction results across different extractions by a user. Retrospective database 100 stores information noted above and is accessible by retrospective tool 105 to retrieve stored information/data, as well as to store new data generated by retrospective tool 100 in any of the manners described below. In one embodiment, retrospective tool 105 and system are independent of the feature extraction system, and feature extraction outputs 22 may be accessed by retrospective tool 105 by initiating such access through a user interface 120 for interactive operation of retrospective tool 105. In another embodiment, the feature extraction tool 20 uses metric set(s) imported from the retrospective database 100 to produce QC charts and uses metric(s) with any associated thresholds to analyze metrics against their thresholds yielding information used by the QC Report and Batch Run Summary. In another embodiment, retrospective tool 105 and system are integrated with the feature extraction system, so that when feature extractions are performed by feature extraction tool 20, the feature extraction results 22 are automatically transferred to the retrospective database 100 and used by retrospective tool 105 to automatically perform functions described below.

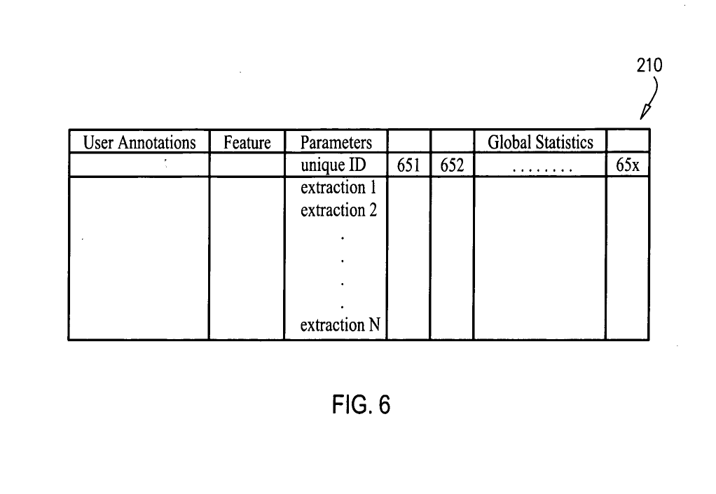

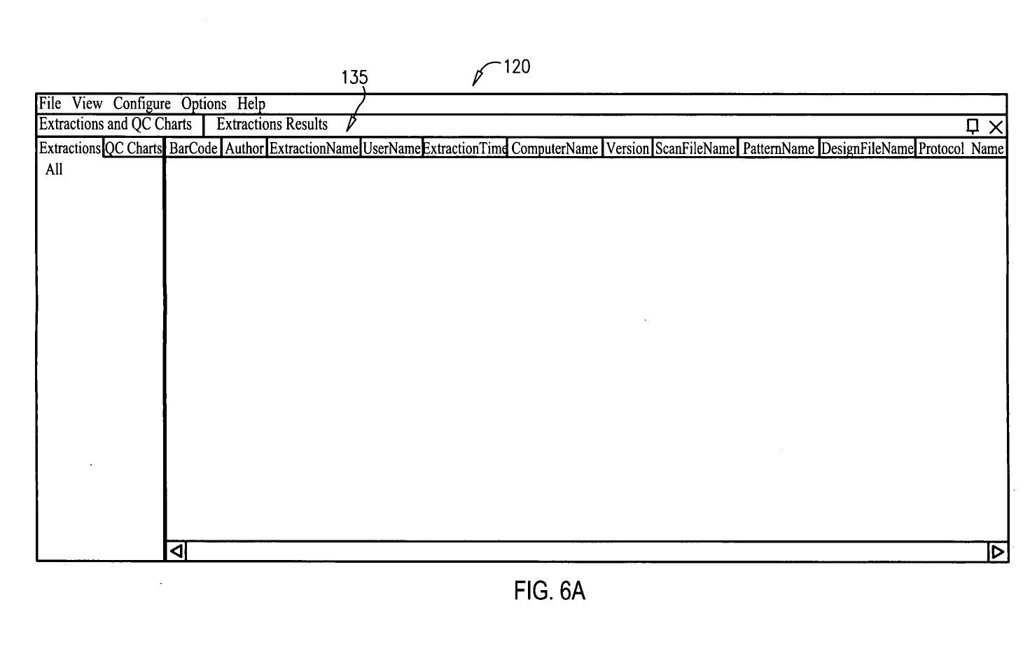

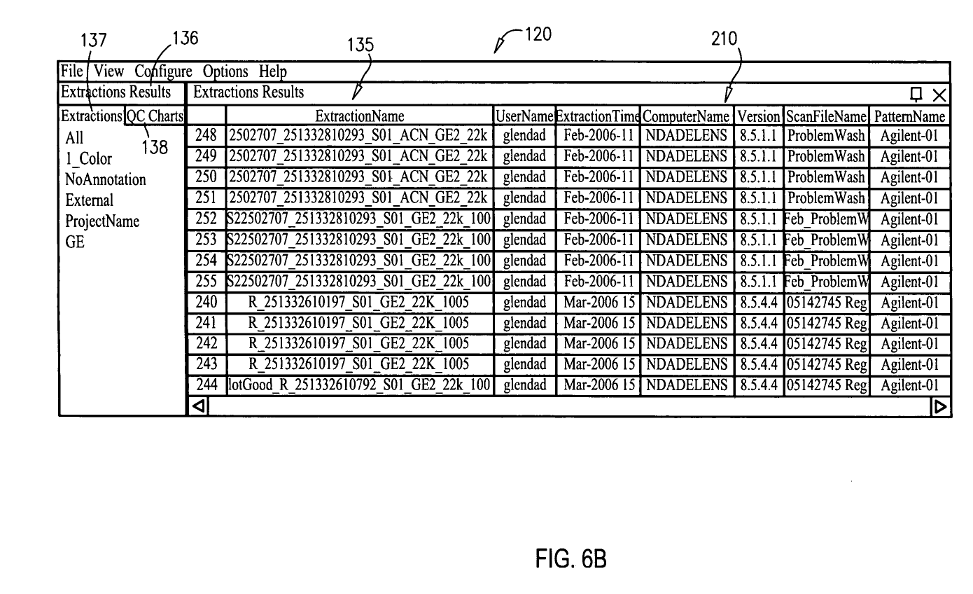

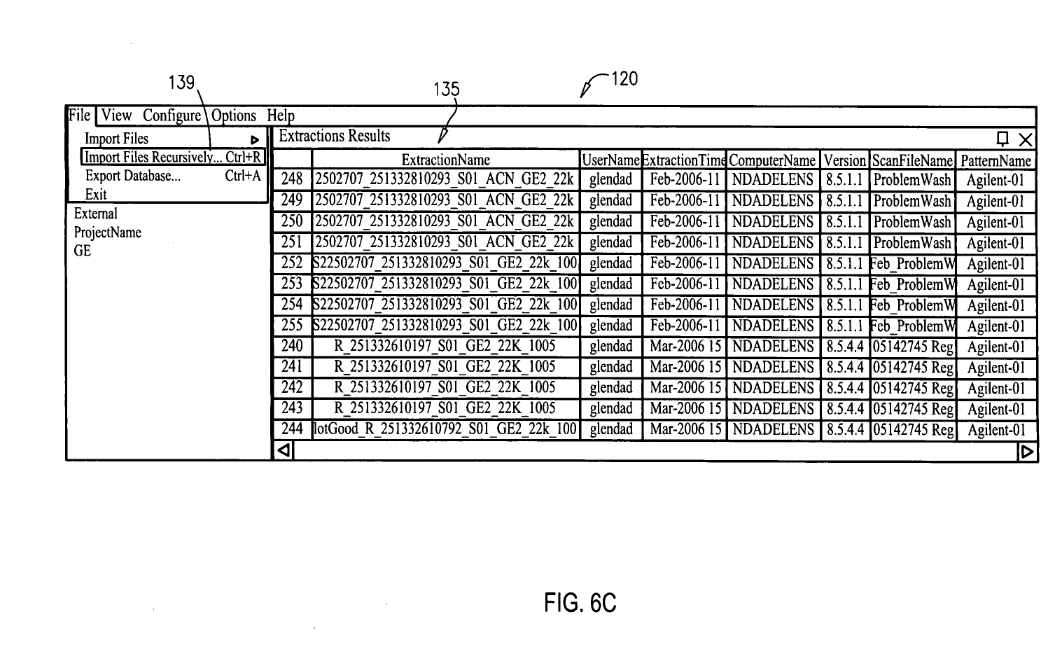

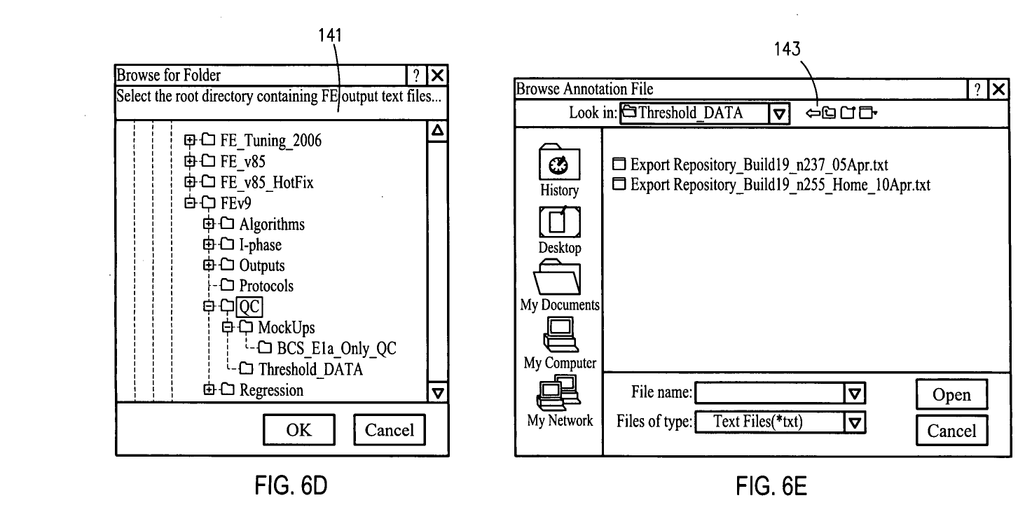

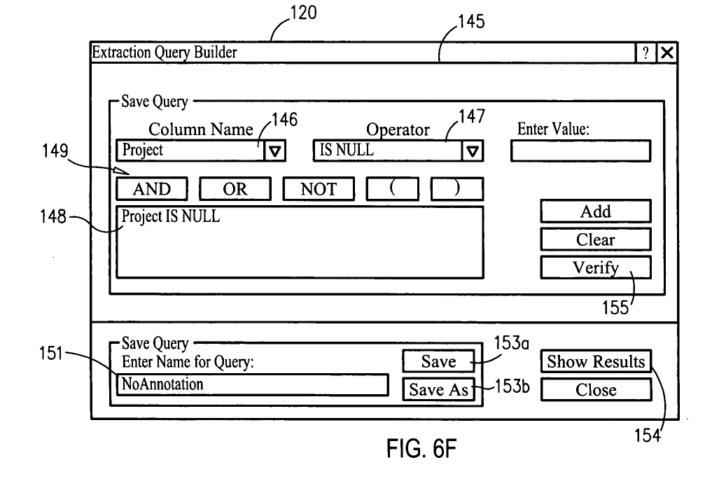

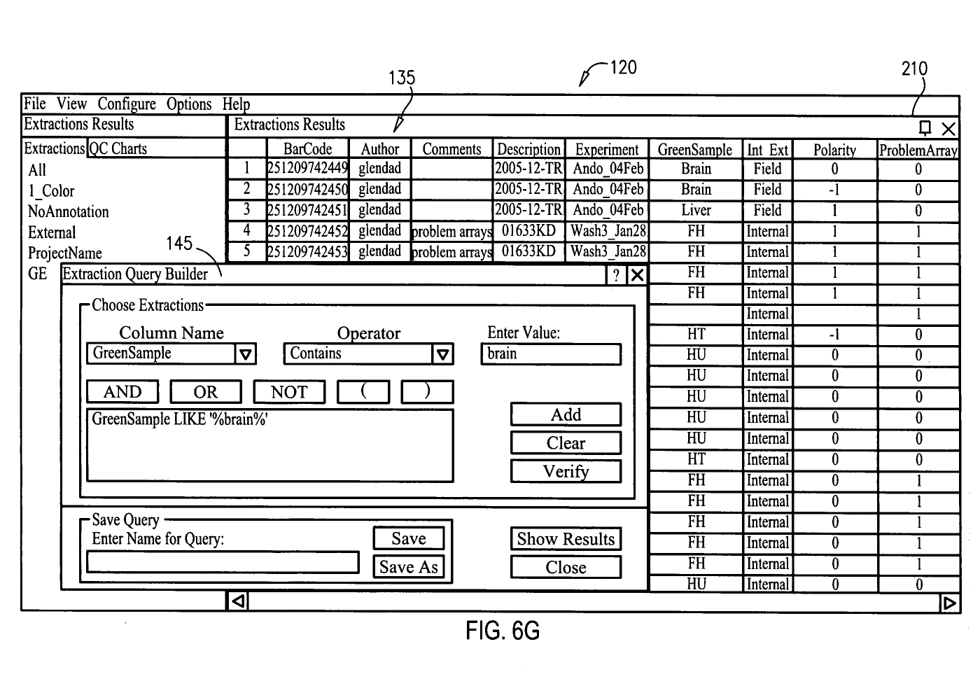

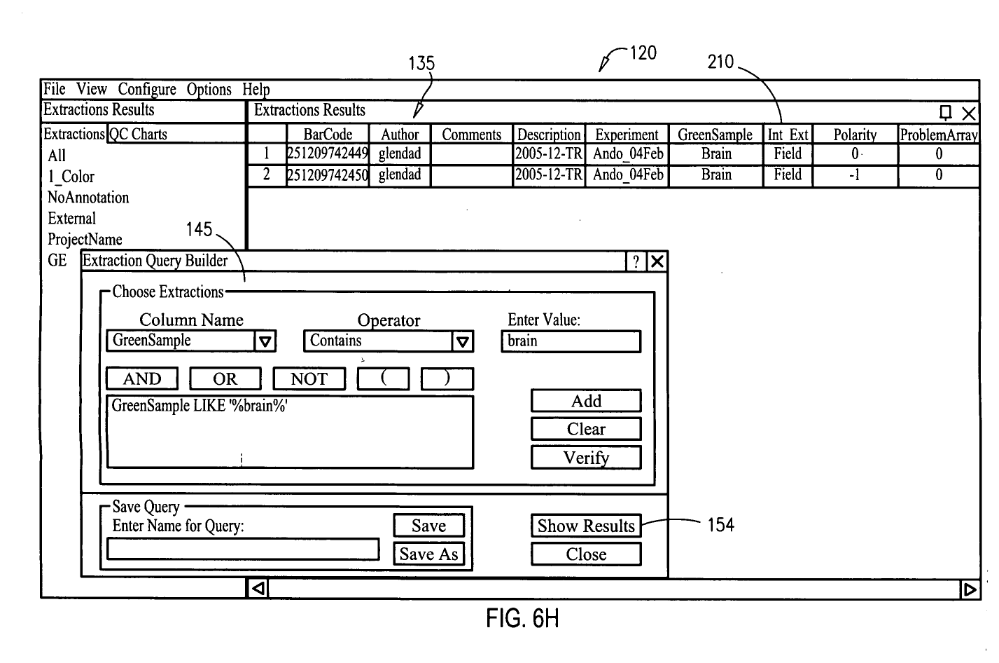

Retrospective tool 105 includes statistics tool 130 that receives feature extraction results 22 as input. Feature extraction results may be received as input automatically, in embodiments where retrospective tool 100 is integrated into the feature extraction system. Alternatively, user interface 120 may be used to access archived text files of feature extraction results 22 to add into database 100, which can then be used as input to statistics tool 130. In either case, statistics tool 130 extracts the global statistics from the statistics portion 24 of each feature extraction output file 22 and at least some of the array processing parameters from array processing parameters portion 23, including a unique identifier for the extraction that the particular feature extraction results file 22 is reporting on. These extracted data are linked by the unique identifier and may be stored in retrospective database. A user may access the retrospective database 100 via user interface 120 to review the global statistics and array processing parameters data that have been stored for all or a subset of all the extractions for which data has been stored. Statistics tool 130 accesses retrospective database 100 in accordance with a user extraction query made from interface 120, assembles the requested features parameter data and global statistics in table form and displays the table as a statistics table 210 on user interface 120. The statistics table 210 is actually a “view” resulting from an extraction query, but may also be called a “table” or “file” even though it is not necessarily stored in a persistent manner. Alternatively, the statistics table 210 may be generated “on the fly” by the feature extraction software. That is, after a batch of extractions have been completed by the feature extraction system, statistic table 210 can be assembled from the array processing parameters and global statistics of the extractions that were just performed in the batch process. An example of statistics table 210 is illustrated in FIG. 6. Statistics table 210 thus includes a single row of global statistics for each extraction performed, with a unique identifier and other array processing parameters that characterize that extraction appearing in the same row. In the retrospective database, of course, this data need not be stored in table format, but is linked so that can be readily assembled as such, or at least called up so that the retrospective tool is informed of which global statistics and array processing parameters belong to which extractions. The data used to generate statistics table 210 may be stored in retrospective database 100 and is referred to as a DataStore file. Thus, reference to the DataStore file and the statistic table can be used interchangeably, unless statistics table is being used to reference the view that is generated from the DataStore file. The DataStore file may be subsequently appended with additional rows of array processing parameters and global statistics extracted from additional feature extraction output files inputted to statistics tool 130 subsequently. Thus, the DataStore file contains data from which a statistics table 210 may be displayed, based upon an extraction query. The DataStore file may thus include global statistics and array processing parameter data for all extractions that data is stored for. The DataStore file can be exported from retrospective database 100 as a flat file.

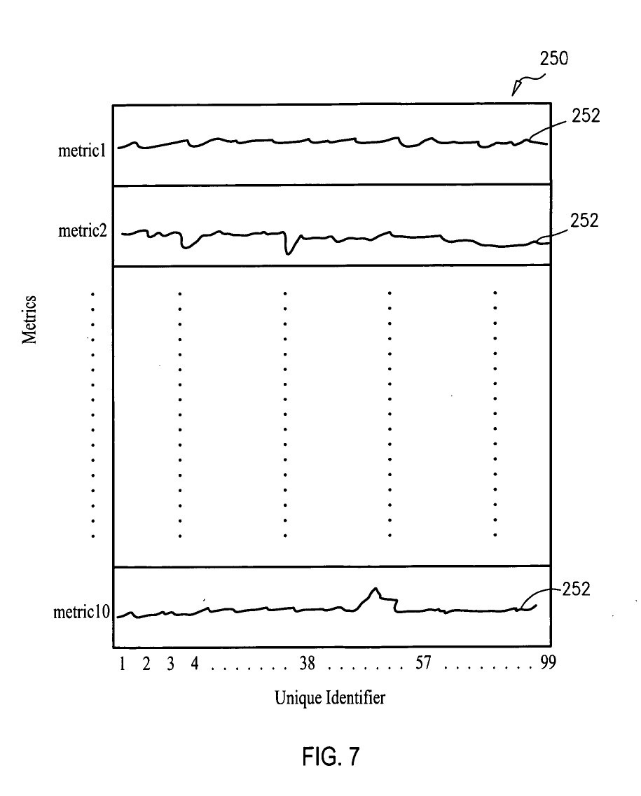

Although the statistics table 210/ DataStore file may additionally include user annotations, as described below, the global statistics data and unique identifier are enough to generate a limited subset of QC charts that may be generated by QC chart tool 140. QC chart tool 140 may access the statistics table 210 from retrospective database 100, using an extraction query and metric set produced by statistics tool 130, to retrieve data for generating a QC chart. Alternatively, QC chart tool 140 may obtain this data directly from statistics tool 130 after statistics tool has processed feature extraction outputs (e.g., with an extraction query) to generate a statistics table 210 or data file like the DataStore file for the current extractions being processed. In examples where the retrospective system is integrated with the feature extraction system, QC chart tool 140 may generate a QC chart 250 (e.g., see FIG. 7) on the fly as feature extraction outputs 22 from the feature extraction batch process are inputted to statistics tool 130 which then inputs its output to QC chart tool 140. Statistics tool 130 in this case may then also automatically input its resulting output to retrospective database 100 to be added to the DataStore file. Alternatively, feature extraction tool 20 may use a metric set imported from retrospective database 100 to generate its own statistics table 210 on the fly, which may be displayed via user interface 30 and/or otherwise outputted (e.g., printed out as hard copy, emailed, faxed, stored in FE database 10, etc.). Statistics table 210 may further be used to generate QC chart 250 and/or information used by the QC Report and Batch Run Summary. The data inputted to the QC chart tool 140 may include all or a subset of the global statistics data for all or a subset of extractions, as determined by the extraction query. Similarly, all or a subset of the array processing parameters may be retrieved, although the unique identifier is always used, since it links the data together for any particular extraction. The DataStore file can be queried, via an extraction query, to identify a particular subset of data that a user wants to work with, as described below. When producing a QC Chart 250 for a current batch of feature extractions, a predetermined metric set may define the metrics to be plotted in charts 252 for all extractions that were processed in the batch. Alternatively, the statistics table 210 resulting from processing the current batch of feature extraction outputs 22 may be filtered by querying, similar to that described with regard to the DataStore file in retrospective database 100.

FIG. 7 illustrates an example of a QC chart 250 as an example where QC chart tool has plotted charts 252 of metric values for ten different metrics for each of ninety-nine extractions from ninety-nine arrays that a user has selected to perform an analysis. The global metric values are plotted against the unique identifiers (which appear across the X-axis in this example, and may be the bar code identifier/label, or a combination of fields/parameters and/or annotations, such as experiment date and bar code identifier; experiment data, polarity and barcode identifier; etc.) for the ninety-nine extractions. Each metric has its own Y-axis, so that these plots may be stacked on top of one another in a single screen visualization on user interface 120 (or 130) or in a single page report. The global statistic values are plotted, and line graphs may be generated between the plotted statistical values, such as by interpolation, point-to-point lines, or the like. QC chart 250 in this way, facilitates the user's ability to readily view and compare/contrast global statistics across different extractions. For example, upon viewing the charts displayed in FIG. 7, a user may readily discern that the values for extraction numbers 4 and 38 for metric 2 and for extraction number 57 for metric 10 may need to be looked at in closer detail, and that these extractions may need to be examined more closely, since the metrics values were expected to be all about the same for all extractions in this case. It is noted that a single metric may be plotted in the same manner, by specifying this through a query.

Referring again to statistics tool 130 and statistics table 210/DataStore file, extra columns/fields may be added to the statistics table 210/DataStore file to include user annotations. User annotations may include experimental annotations, e.g., identification of red sample (e.g., liver cells from oncogenetic mouse), identification of green sample (e.g., liver cells from normal mouse-control), date of experiment, project name, Department of person(s) conducting the experiment, name of study, etc. User annotations may be freely defined, so that the user may include any annotation that the user may find useful in locating an extraction and or comparing or differentiating an extraction from other extractions. User annotations may be filled into statistics table 210 directly by a user through interface 120, wherein they are also saved in DataStore file 100 in a manner corresponding to the modified statistics table 210. Alternatively, a text file of user annotations (such as a Microsoft Excel® spreadsheet, for example, or the like) containing user annotations associated with the unique identifiers of extractions to which the user annotations are to be added, may be inputted to statistics tool 130 which populates statistics table/DataStore 210 with the user annotations in the input file by associating them with the unique identifiers included in the input file and matching to the same unique identifiers in the existing statistics table 210/DataStore file. Any of the user annotation fields, array processing parameter fields metrics fields, specific user annotations, specific array processing parameters, specific unique identifiers for extractions, and specific global statistics values, in any non-contradictory combination, may be used in defining an extraction query to select specific subsets of information from statistics table 210/DataStore file.

In addition to plotting charts 252 of metrics as described above, QC chart tool may also calculate summary statistics from the metrics that have been plotted in the charts 252. For example, if metric 1 plots average log signal of red to green signals for all experimental probes on an array, QC chart tool 140 may calculate the average value of all of the ninety-nine average log signal values provided for the ninety-nine extractions reported on in FIG. 7. Additional summary statistics may also be computed. For example, QC chart tool 140 may calculate the standard deviation of the distribution of those ninety-nine average log signal values plotted. Robust summary statistics may also be calculated, including, but not limited to median, interquartile range, etc, as well as multiples of such derivative statistics, including, but not limited to: some multiplier times the standard deviation (e.g., 3*standard deviation, which may be useful for setting thresholds, described below), some multiplier times the interquartile range (e.g., 1.42*interquartile range), etc. The summary statistics, when calculated, may also be displayed on the charts 252 (e.g., lines plotted on charts to show ± three standard deviations, etc.), which may help the user to determine whether a metric value is within or without of a range considered to be acceptable for use. More generally, thresholds may be plotted on charts 252 regardless of how they are generated (e.g., calculated or set by a user).

Charts 252 in a QC chart produced after a batch of feature extractions are processed, may be linked to QC reports 40 such as by hyperlinking or other linking feature so that selection of a particular data point on a chart 252 automatically opens the QC report 40 on which that metric appears, i.e., for that extraction. Note that links can only be provided for those metric which appear in both the QC chart 250 and QC reports 40, and that some metrics (e.g., derivative statistics, or some global statistics that may have been taken from the statistics table 210/DataStore file to be plotted in QC charts 252, but which are not reported in QC reports) that may be plotted in QC chart 250 may not be reported in the corresponding QC reports 40. In these instances, if a hyperlink is provided, selection of the hyperlink simply opens the QC Report for the extraction selected.

Queries

As noted above, retrospective database 100 may be queried by a user via user interface 120 to select all of the data in DataStore file or a selected subset thereof. Any of the user annotation fields, array processing parameter fields metrics fields, specific user annotations, specific array processing parameters, specific unique identifiers for extractions, and specific global statistics values, in any non-contradictory combination, may be used in defining a query to select specific subsets of information from statistics table 210/DataStore file. A query to used to select a subset of extractions from statistics table 210/DataStore file is called an extraction query. Similarly, if the feature extraction system and retrospective system are linked to allow cross-querying of databases 10 and 100, a user may define an extraction query to be used by statistic tool 130 to obtain a selected set of feature extraction outputs if feature extraction outputs are stored in the feature extraction database, to add statistics and parameters of those extractions selected to DataStore file. As noted above, feature extraction results may alternatively be automatically transferred to database 100.

Thus, extraction queries may be used to select particular extractions to be used to produce charts 250. The extractions provided the X-axis entries for the charts 252 that are produced. User-defined metric sets may be used to determine which metrics are to be displayed in charts 252 of QC chart 250. That is, a metric set may determined the Y-axis selections for QC Chart 250. Queries may be saved in retrospective database 100 so that a user may reuse the same query without having to regenerate it. Queries may optionally be linked to the data that was obtained from the query when the query was first run. For example, the user may select to have the extraction query time stamped when it is run, so that if an extraction query is subsequently resubmitted on a later date, the results will be the same as when the query was first run. Alternatively, a query may be saved without time stamping it, so that each time it is submitted, the data retrieved will include any additional data that matches the requirements of the data that was not present on the previous submission, but which was subsequently added to the DataStore file. Further alternatively, the query itself may include a specification for a date field of one of the date fields that are stored with the data in DataStore file. For example, user annotation fields may include such date fields as scan date, feature extraction date, the date that the statistics and the array processing parameters were added to the statistics table/DataStore file, the date that a record (which corresponds to a row of the statistics table) was last modified, and/or the date that the experiment was conducted. A user may include in the query, one or more limitations that require that only data before one a certain date, after a certain date, or within a specified date range of one or more of these date fields is retrieved. When creating thresholds for evaluation of metrics calculated from feature data, it may be important to set specific date limitations on the extraction query used to obtain data from which a threshold was determined, for repeatability, traceability and regulatory reasons, so that it can later be shown how a threshold was derived, by providing the ability to easily retrieve the same data from DataStore file that was originally retrieved for use in creating the threshold. Metric sets that contain metrics to be used for generating QC charts 250 for evaluating extractions, and which may include threshold settings, may be stored in database 100 with a link to each query used to obtain data that was used in creating a threshold. As noted, these queries may be constructed to as to be date restricted, so that by resubmitting any one of these queries, the same data will be retrieved as when the query was run to retrieve data to generate the threshold.

Metric Sets

A metric set contains the metrics that are used to evaluate the extractions, for example to display charts 252 in the QC chart 250. Metric sets may be customized for different array (extraction) applications. For instance, a metric set may be different for gene expression that for CGH array extractions. Also, metric sets may differ for extractions processed on only one signal channel (i.e., “one color” mode) versus extractions processed on two signal channels (i.e., “two color” mode). Further, metric sets may differ depending upon the stringency of the hybridization and wash protocols used to prepare the arrays prior to extraction, or other variable determined important by the user. Metric sets may be stored in retrospective database 100. Alternatively, a user may import a desired metric set into FE database 10 and then link that metric set to a feature extraction protocol. The manufacture of the feature extractions system may provide metric sets with FE database 10 and link specific feature extraction protocols to appropriate metric sets. Alternatively, the user may link a metric set to an entire feature extraction project.

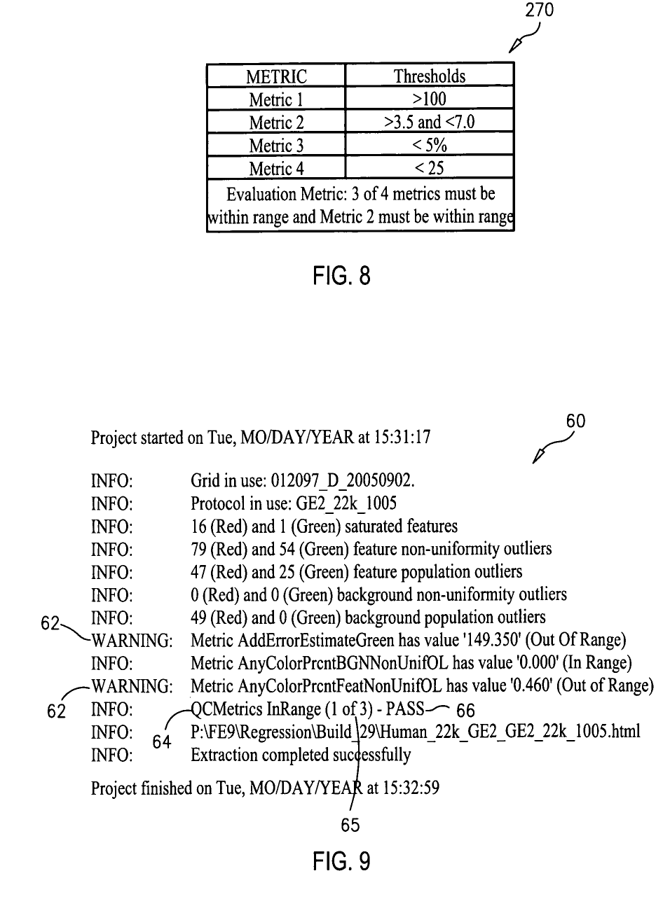

There may be three aspects to a metric set as illustrated in metric set table 270 shown in FIG. 8. First, metric set 270 identifies the metrics that are to be used to evaluate the extractions. Second, if one or more thresholds is associated with a metric listed, the thresholds are identified in the metric set 270. If thresholds are present, then an evaluation metric may be set, and this is also indicated in metric set 270. An evaluation metric is a rule based upon the results of the other metrics identified in the metric set, and which may be user settable. The evaluation metric may then be used by the retrospective system or by FE tool 20 to make a decision as to whether a particular extraction is within acceptable limits or not. The evaluation metric may be set so that an extraction is within acceptable limits if the metrics for a predefined percentage or number of all the metrics used are within the threshold settings. Additionally, the evaluation metric may weight or set the importance of one or more metrics to be higher than the others. In the example shown in FIG. 8, an extraction may be considered acceptable if three of the four metrics measured are within acceptable limits, as long as the value for metric 2 is within acceptable limits. Using these rules, the evaluation metric can give a score to an extraction of either “pass” or “evaluate”, for example.

Metrics may be added to or deleted from a metric set 270 by a user via interface 120. As a metric is added, summary statistics are calculated using the data defined by the extraction query. The user may choose the type of statistic summary (e.g., standard, robust, manual, etc.) and may choose multipliers to be used in the calculation of a threshold (e.g., upper limit−mean plus 3*standard deviation, etc.) Although the feature extraction tool 20 is the primary intended user of metric sets, retrospective tool 110 may also do an evaluation of extractions selected using an extraction query, based on a metric set.

Thresholds

The feature extraction system, by itself calculates statistics based only upon the feature data obtained from the extractions that were processed in the current batch extraction process. In order to set thresholds to help a user determine whether a particular metric for a particular extraction is within expected limits or outside of expected limits, statistically better estimates for threshold setting can be established if the database upon which the thresholds are calculated contains many more extractions, having the corresponding global statistics values of interest, than just those extractions that are currently being batch processed. Because the retrospective database 100 stores such information in DataStore file for additional extractions, as noted above, it can be queried to obtain statistics from additional extractions that are similar to the extractions to be evaluated according to one or more array processing parameters and/or user annotations. Alternatively, retrospective tool 105 may calculate statistics only from the global statistics produced by a current batch run of extractions to be used in setting thresholds to use in evaluation of the same extractions. This may be a user selectable option. Still further, in embodiments where the retrospective system is integrated with the feature extraction system, retrospective tool 105 may calculate thresholds for the metrics to be used to create QC chart “on the fly” from global statistics outputted in the feature extraction output 22 for the current batch extraction process.

As an example of creating thresholds from metrics resulting from a query of DataStore file in database 100, and following an example above, a user may query retrospective database 100 (or a flat file containing DataStore file having been exported from database 100 as an Access, Excel or other file, for example), wherein the extraction query requests all records (extractions) containing liver cells from oncogenetic mouse as red sample experimental probes and liver cells from normal mouse as green sample control probes. The results of such query may return global statistics, array processing parameters and user annotations (i.e., records) for a much larger number of extractions than what are processed in a single batch run. For example, the extraction query may return 1500 records. The metrics from each of these records may then be used, per metric to be evaluated, to calculate statistics over all 1500 extractions. Retrospective tool 105 may perform these statistical calculations, or call on a statistical and/or plotting software package (e.g., Microsoft Excel®, Microsoft Access®, Spoffire®, or the like) to calculate statistics such as average, standard deviation, minimum, maximum and/or robust statistics such as median, interquartile range, multiples of other statistics, etc. Prior to calculating statistics for any given metric, the user may first review the extractions selected for the calculations, via user interface 120, and exclude one or more extractions from the calculations. For example, the user may find some anomaly in an extraction that the user believes may skew the statistics, or for any other reason that the user may want to exclude an extraction. For each metric for which statistics are calculated, retrospective tool 105 may set default thresholds based upon the statistics calculated from the set of metrics (global statistics) inputted. A user may interactively change one or more of the automatically set default thresholds via user interface 120. A user may also select, where appropriate, among a single threshold or multiple thresholds. For example, a user may select a single threshold (e.g., greater than one hundred) or multiple (e.g., a “range” having both low and high) thresholds (e.g., greater than one hundred, less than one thousand). A threshold file may be stored in the associated metric set which is stored in database 100. The threshold values for each metric, as provided by retrospective too 105 are then retrievable from the stored metric set and can then be re-used with other extraction queries or modified by the user.

The threshold file may also be linked to FE database 10 through the metric set in embodiments where the retrospective system is incorporated into the feature extraction system. Alternatively, a user can import the desired metric set into FE database 10 and then link that metric set to a feature extraction protocol. In this case, for each metric calculated from global statistics and reported in the feature extraction output 22, or metrics calculated as derivatives of one or more global statistics, one or more statistics, one or more user annotations (particularly when user annotations are numeric: for example, a user may select to add an RNA quality score from a BioAnalyzer (Agilent Technologies, Inc., Palo Alto, Calif.) trace as a user annotation, and include this as a metric, or calculate a derivative statistic from this to be used as a metric), or some combination of these, feature extraction tool 20 may evaluate each metric for which a threshold is present in the threshold section of the metric set, and report which metrics are not within the threshold settings and optionally, which metrics are within threshold settings. Metrics that are outside of threshold limits may be reported in a Batch Run Summary (Project Run Summary) 60 that is outputted at the end of a batch feature extraction project by feature extraction tool 20, as warnings 62, as illustrated in FIG. 9. These warnings may be linked to QC Chart 250, so that when a warning is clicked on by a user, QC Chart 250 is displayed on user interface 120, with the metric(s) that is not within threshold limits being highlighted on the chart 252 in which that metric is plotted. By clicking on the highlighted metric on the chart 252, statistics table 210 is displayed on the user interface, with the row containing the extraction having the highlighted metric in chart 252 being highlighted in statistics table 210. This allows the user to readily review all of the global statistics for that extraction, associated feature extraction parameters, and any annotations that may have been inputted. If table 210 was generated by retrospective tool 105 and displayed on user interface 120, then the user can add user annotations via user interface 120. However, if table 210 is generated “on the fly” after a batch feature extraction process has run, then user interface 30 may be used by the user to add user annotations, either before or after the batch has been extracted. If the metric clicked on is a derivative of two or more global statistics, then two or more fields are highlighted in the statistics table 210 to highlight those global statistics from which the metric is derived.

Additionally or alternatively, extraction scores 64 may be reported for each extraction in Batch Run Summary 60. Extraction scores may be reported numerically (textually) 65 or as percentages, and/or graphically 66, for example, by displaying a pie-chart with a percentage of the pie filled in or colored to represent the percentage of metrics within limit, or bars, circles or other symbols, one for metrics within limits and one for metrics exceeding limits, wherein the sizes of the symbols are scaled to their numbers relative to one another, or some other graphical representation to readily visually convey to a user the size(number) of metrics within limits relative to those that exceed limits.

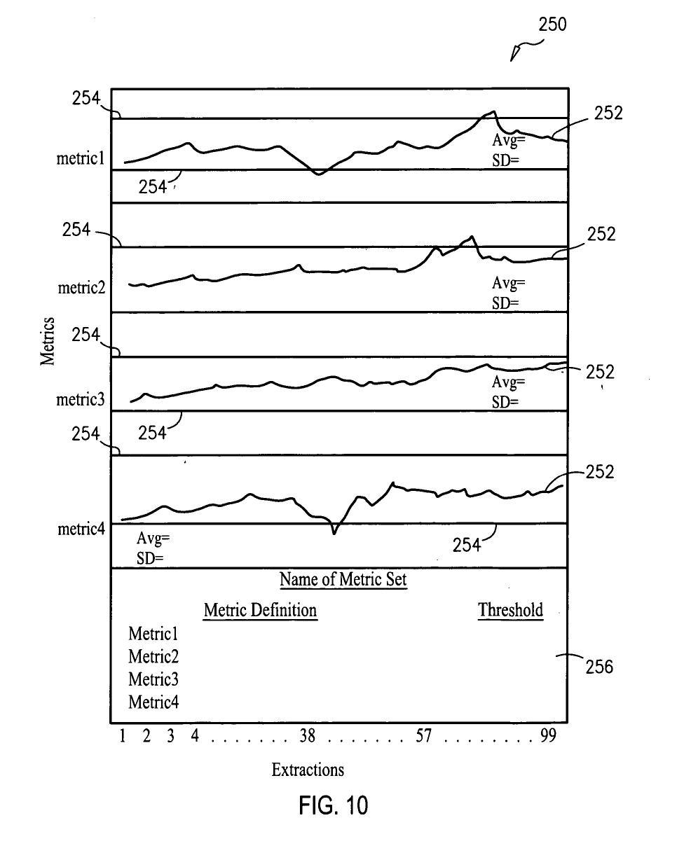

Alternatively, or additionally, a summary of the number of statistics which are within and/or those that are outside of the thresholds may be reported in the QC report 40, such shown in table 256 of FIG. 10, for example. By clicking on the summary, QC chart 250 is displayed with all of the metrics that are outside of the threshold limits being highlighted in the charts 252 where they appear. Those metrics that are outside of the thresholds may be identified individually in the QC report 40, and then may be individually clicked on so that only the statistic clicked on is highlighted in the QC chart that is displayed in response to this action. This is possible only for those metrics that are equal to or derived from a global statistic(s) that is presented in the QC Report 40. Extraction scores 64 may be reported in QC report 40 for each individual extraction in any or all of the same ways described above with regard to Batch Run Summary 60. Additionally, or alternatively, either or both Batch Run Summary 60 and QC Report may display an evaluation result 66 that summarizes the result of the evaluation according to the criteria of the evaluation metric. For example, a textual message may indicate “PASS” or “EVALUATE” or “HOLD FOR EVALUATION”, depending upon whether the evaluation metric is within limits or out of limits. Evaluation results may optionally be color-coded to further draw attention to the user. For example, “PASS” may be in blue or green, while “EVALUATE” or “HOLD FOR EVALUATION” may be colored red or yellow. Evaluation results (in any from described above) may also be included in the feature extraction results 22 in embodiments where the retrospective system is integrated with the feature extraction system. In examples where evaluation results are determined when running a batch extraction, an integrated system may be configured to automatically pass those extractions with a “PASS” evaluation downstream of the system for further processing, evaluation and/or use. Those extractions with an evaluation result of “EVALUATE/HOLD FOR EVALUATION” are automatically held and not passed along with those extractions having a “PASS” evaluation, as they will need to be further reviewed by a user, and manually approved to be passed downstream, or rejected.

Tracking of the evaluation results of extractions can be performed and stored in DataStore file/statistics table 210, as linked by the unique identifiers of the extractions. For example, an additional column in statistics table 210 (and corresponding additional field in DataStore file) may track whether an extraction has required manual review. For those that initially pass, this field/column will indicate no manual review. For those that have been manually reviewed, this field/column will indicate such. Accordingly, the system is configured to track and record this data for subsequent analysis. For example, future thresholds for a metric set can display the percentage or number of extractions in the extraction selected by an extraction query that have evaluations results that match the user generated manual evaluation, which may serve as an indicator as to how effective the set threshold is at distinguishing between acceptable and unacceptable extraction results, and thus, how effective the threshold and evaluation set are at mimicking a manual evaluation by a user.

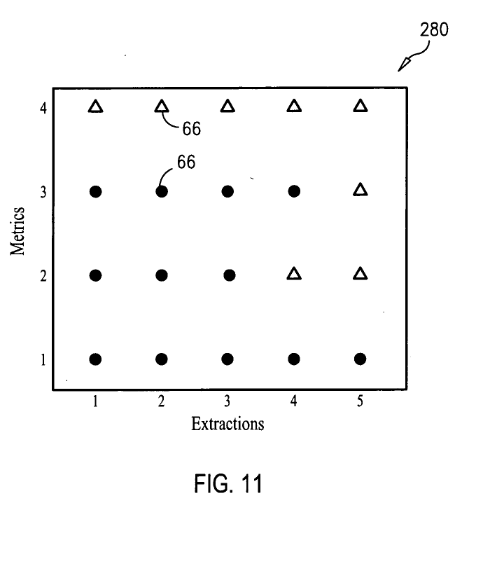

FIG. 11 shows an example of a Summary Plot 280 generated by retrospective tool 105 after evaluating five feature extraction results data files/reports 22 generated by feature extracting a batch of five extractions. Evaluation was based on a metric set 270 containing four metrics with thresholds and a defined evaluation metric. Thus, evaluation results 66 are displayed in Summary Plot 280 for each metric per each extraction. In Summary Plot 280, evaluation results 66 may be displayed graphically and/or color coded. In the example shown in FIG. 11, evaluation results 66 are shown as triangles and colored red for those global statistics that are outside of the threshold limit(s) and evaluation results 66 that are within limits are circles that are colored blue. Summary Plot 280 may be dynamic in that evaluation results 66 may be linked to QC Chart 250 so that clicking on an extraction result symbol 66 causes QC Chart 250 (or only chart 252 that the corresponding statistic is in) to be displayed on user interface 30 or 120. Optionally, the data point in chart 252 that corresponds to the global statistic represented by the evaluation result symbol 66 clicked on may be highlighted in chart 252 that is displayed. Alternatively, the Summary Plot 280 can be generated by FE tool 20 after a batch of extractions have been run. In addition to the above-mentioned dynamic links, if a user clicks on an extraction (i.e., an X-axis value of charts 252 or 280), this causes the QC Report 40 that is associated with that extraction to open and be displayed.

FIG. 10 illustrates a QC chart 250 created using a metric set 270 having four metrics specified. Each of the metrics in the metric set 270 have thresholds associated therewith and the thresholds 254 are also shown, plotted on charts 252. It can be observed that metrics 1 and 3 have upper and lower threshold settings 254, metric 2 has only an upper threshold setting 254, and metric 4 has only a lower threshold setting 254. Those values that are not within the threshold settings may be highlighted so that they are more readily brought to the user's attention when viewing QC chart 250. In FIG. 10, the value for metric 1 for extraction 70 is shown to exceed the threshold, the values for metric 2 for extractions 68 and 70 exceed the upper threshold limit 254 and the value for metric 4 for extraction 49 is outside the lower threshold limit 254. As noted these data points may be highlighted, and the user, when viewing these charts may be prompted to review the data for extractions 49, 68 and 70 more closely. One way of reviewing these extractions in more detail is to click on a highlighted, out of limit, value. The data points are linked to the statistics table 210, which is then displayed on user interface 30 or 120 and the row in which the extraction having the statistic that was clicked upon in the QC chart 252 may be highlighted so that the user can readily locate it and review the global statistics, array processing parameters and any user annotations associated with that extraction.

At the bottom of QC chart 250 a summary of the metrics 256 used to create QC chart may be listed. The summary may include the global statistic (or derivatives) used to define each metric, the threshold values 254 (upper and/or lower limits) against which the global statistics are compared, and the name of the metric set 270 containing these metrics, as stored in database 100. Additionally, one or more summary statistics may be calculated based on the global statistic values in a plot 252, as noted above. These summary statistics may be displayed in QC chart 250, adjacent charts 252 that they pertain to, or at the bottom of chart 250 with appropriate identifiers. As noted above, the thresholds may be user set or modified, using metric sets calculated by retrospective tool 105. Alternatively, the metric sets may be imported from the retrospective database 100 into the feature extraction database 10 and linked to feature extraction protocol(s). Alternatively, in embodiments where the retrospective system is integrated with the feature extraction system, a feature extraction protocol may be linked to a metric set residing in retrospective database 100. The summary of metrics 256 used for an evaluation metric may also be included in a QC Report 40 as shown at the bottom of FIG. 5. The name of the metric set 270 is listed at the top of the summary and the names of each metric in the metric set used to perform the evaluation are listed, as described above. In the example shown in FIG. 5, the summary metrics are color coded (although this is not apparent in the black and white fig.) so that the metrics that are within range of the thresholds set are color coded a first color 256g (e.g., green) and the metrics that are outside of a threshold and need to be evaluated are color coded with a second color 256r (e.g., red). In this example, the evaluation metric was set to pass if one out of three metrics are within range, so the summary evaluation 256e indicates “PASS”.

Customizing the Retrospective Tool

The retrospective tool 105 is customizable by a user to provide easy, traceable and reproducible development of thresholds. Retrospective tool 105 also provides for the extension of the global statistics provided in feature extraction outputs 22 by allowing the user to instruct calculation of derivative metrics as mathematical functions of the global statistics provided by feature extraction output 22. For example, the user may instruct retrospective tool 105 to define a new metric as the absolute value of the global statistic “eQCObsVsExpLRSlope” (“eQCObsVsExpLRSlope” is a global statistic for the slope of the fit of a linear regression of the log ratios of eQC “spike-in” probes, to show observed versus expected values) and/or to define another new metric that is defined by the ratio (or other algebraic combination) of two or more existing metrics. The user may also instruct retrospective tool 105 to perform summary statistics of metric values across multiple extractions. As another example, the user may instruct retrospective tool 105, via interface 120 to calculate “3*SD”, where “SD” is a standard deviation of the global statistic “NumFeatureNonUniformOlr” reported in feature extraction output 22. Other derivative metrics may be calculated, as noted above.

A user may determine what data is to be plotted in QC chart 250. As described above, the user may query DataStore file is retrospective database using query terms that may include any of the user annotation fields, array processing parameter fields, metrics fields, specific user annotations, specific array processing parameters, specific unique identifiers for extractions, and specific global statistics values, in any non-contradictory combination. The metrics to be displayed in QC chart 250 (along the Y-axis) may be included in a stored metric set called directly by a term in the QC chart query. The extractions that are plotted in the QC chart 250 (i.e., along the X-axis) are defined by the extraction query term in the QC chart query. As noted above, queries can be saved in retrospective database 100.

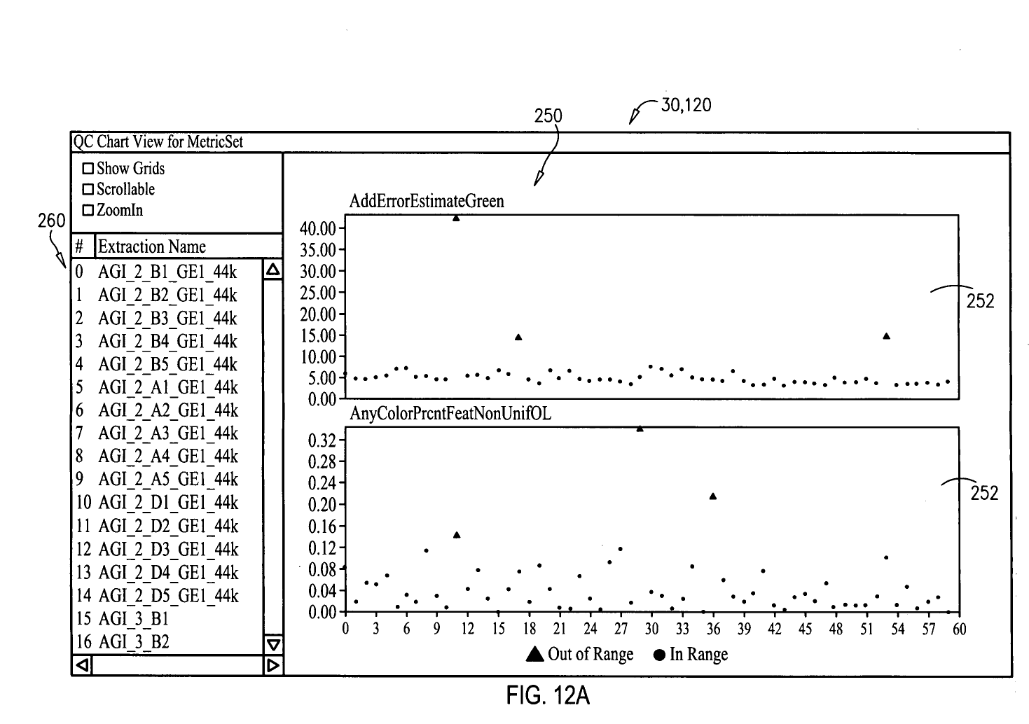

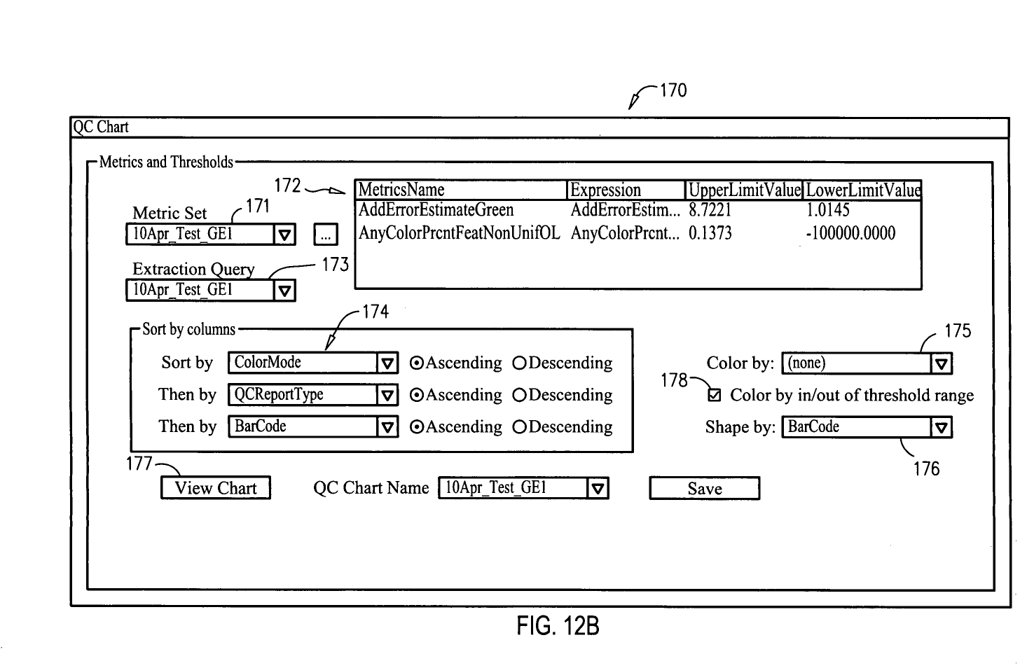

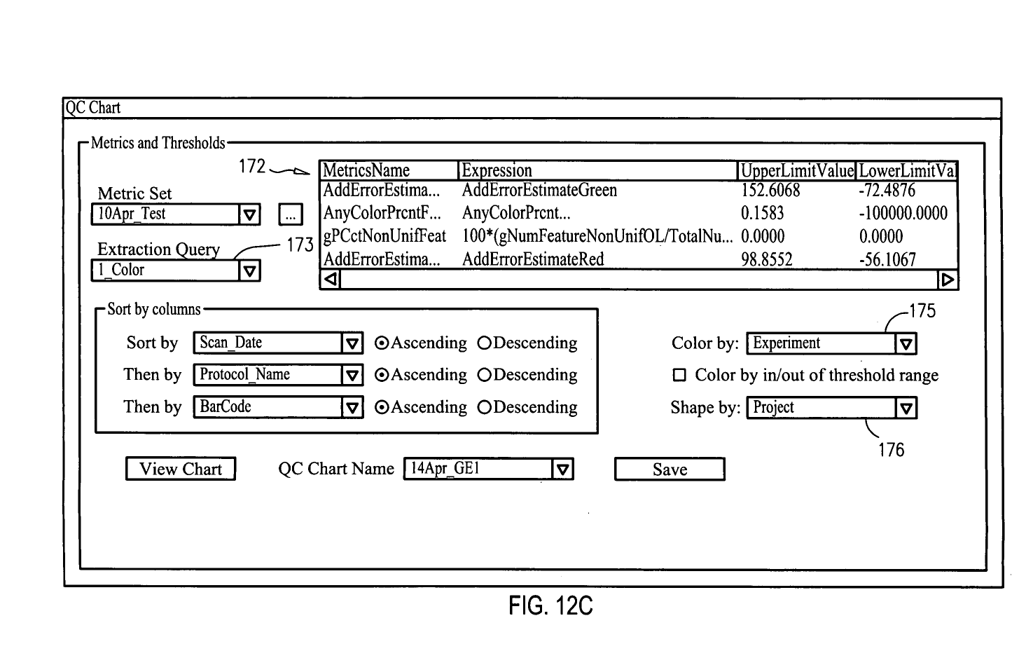

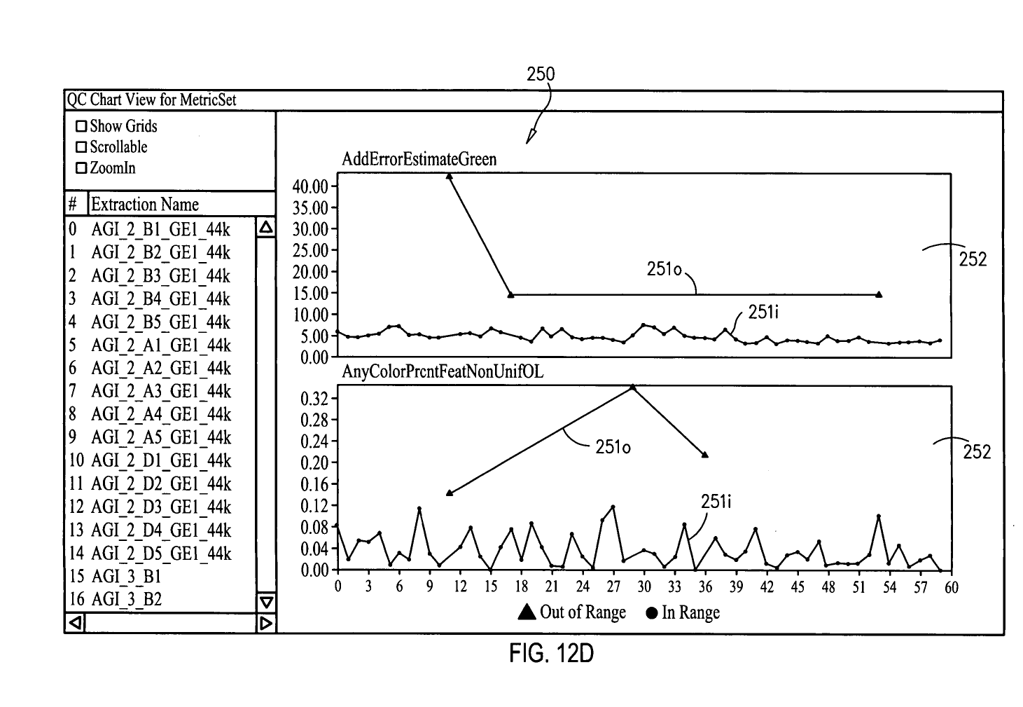

Further, the layout of QC chart 250 can be selected/customized by a user and saved in a QC Chart preferences file in database 100. The extractions plotted along the X-axis may be selected to be identified by barcode identifiers of the extraction, abbreviated barcode identifiers (e.g., the last three digits of each identifier), feature extraction batch extraction number, integers (e.g., from 1 to N) or other unique identifier that uniquely identifies the extraction data being plotted as originating from that extraction. FIG. 12A shows an example of charts 252 in QC chart 250 where the user has selected to use integer numbering to identify the extractions along the X-axis. The retrospective system links the integers to the unique identifiers of the respective extractions, so that when clicking on one of the data points, statistics table 210 can be displayed with the row for the extraction corresponding to the data point clicked upon being highlighted. Additionally, in this embodiment, an extraction name table 260 is displayed alongside QC Chart 250 in the view on user interface 30 or 120. With this arrangement, by clicking or mousing over a data point in a chart 252, the extraction name of the extraction from which that data point was plotted is highlighted in the extraction table 260, so that the user can easily identify the extraction name and the integer number of the X-position in which the data point is plotted. In addition, the entire row of data for that extraction may be seen in the statistics table 210, including all user annotations, array processing parameters and global statistics associated with that extraction. Alternatively, if the QC chart 250 is produced by FE tool 20 (and displayed on user interface 30, for example) the integer numbers along the X-axis can be linked to the extraction numbers in the feature extraction batch of extractions having just been processed. If the user sorts, orders, groups and/or colors extractions based on some parameter, these parameters may also be displayed in table 260.

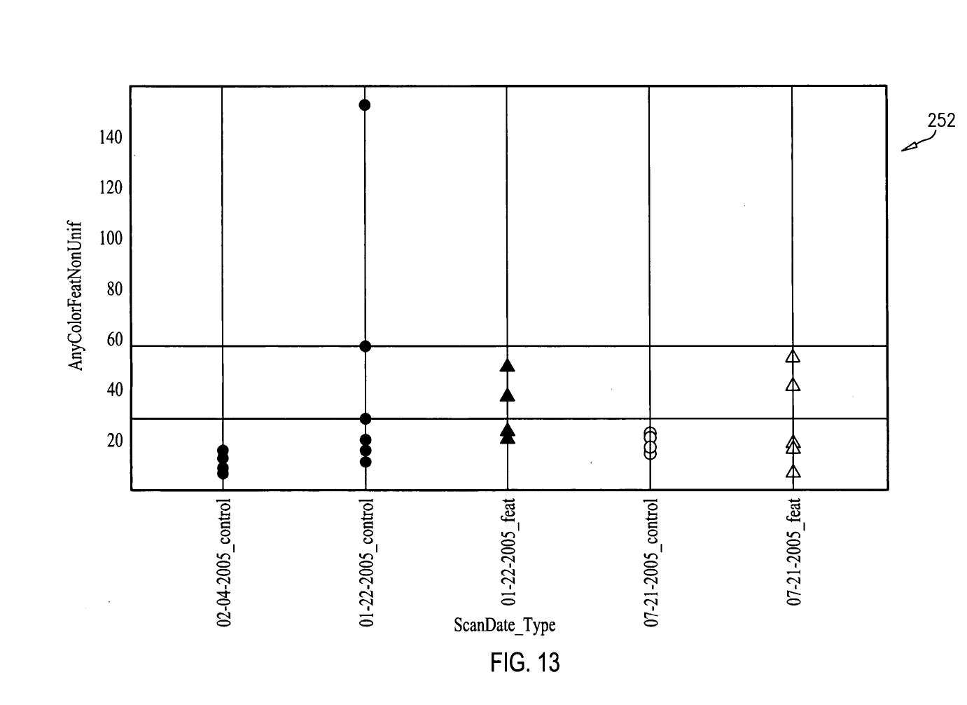

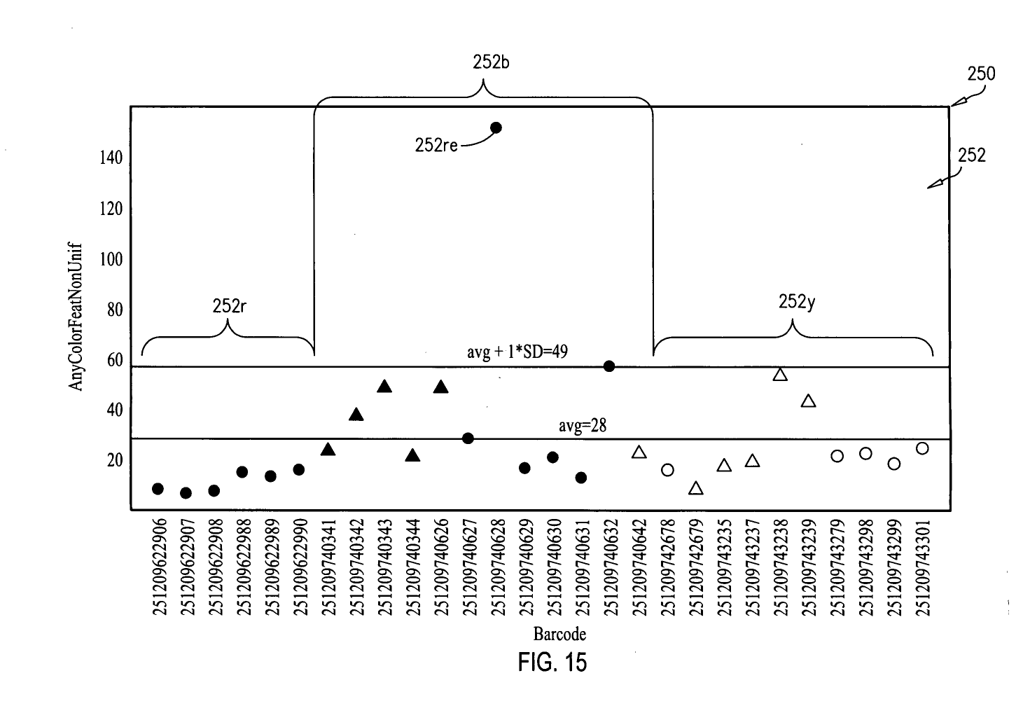

The user may choose to plot charts 252 separately in QC charts 250 (e.g., see FIG. 15), so that each QC chart displays only one plot 252. Alternatively, chart plots 252 may be stacked, as illustrated in FIGS. 7, 10 and 12. As another option, the user may choose grouping or stacking of extractions displayed along the X-axis. FIG. 13 illustrates an example of this, where the metric for nonuniform features of any color have been plotted by groups of extractions as grouped by the same scan date and type (e.g., “control” or “test”). Stacking or grouping may also be performed sequentially. For example, the user may select to stack four extractions for each entry along the X-axis.

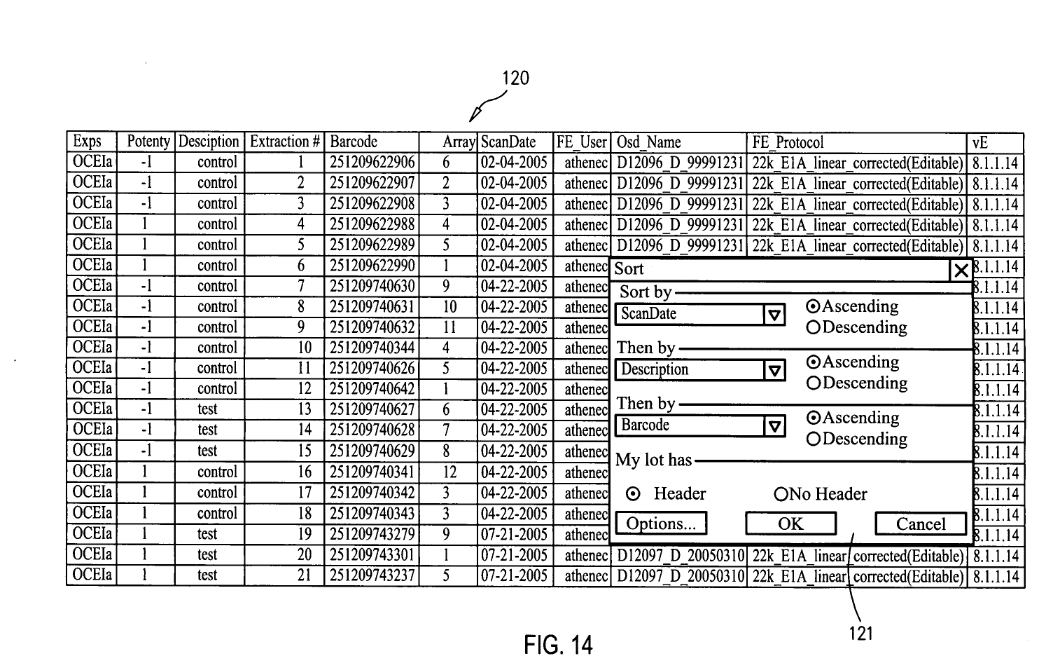

The ordering of presentation along the X-axis may have a default value that orders the extractions numerically according to the unique identifier chosen to be displayed. However, the user may select which field in DataStore 210 to use for ordering, whether that field is what is displayed on the X-axis or not. A drop down list 121 may be selected in user interface 120 that permits the user to make such selection, as shown in FIG. 14. The user may also select as to whether the ordering is to be displayed according to ascending or descending order. Further, the user may select more than one field and prioritize which ordering takes precedence. For example, in FIG. 14, the user has selected the order to be performed first according to scan date of the extractions (in ascending order), then on description (in ascending order) and finally on the bar code identifier (in ascending order).

The user may also select which statistics will be displayed. Thresholds may be selected to be displayed if a threshold list has been stored in the metric set used to generate the QC chart 250. This metric set is either stored in the retrospective database 100 used by the retrospective tool 105 for charting or has been linked to a feature extraction, either at the project level or linked to specific protocol(s) for QC charting after a batch feature extraction. If summary statistics are to be displayed, the user may select among standard statistics (e.g., mean, standard deviations, minimum, maximum, etc.) and derivatives of standard statistics (e.g., mean+3*standard deviation, etc.) or robust statistics (e.g., median, inter-quartile range (IQR), that is, range between 25^{th} and 75^{th} percentiles, etc., and derivatives of robust statistics (e.g., 75^{th} percentile+1.42*IQR, etc.). If a threshold list has been provided for the extractions to be plotted, then the type of summary statistic that was used to determine the threshold for a particular chart 252/metric can be selected to be displayed.

A user may choose to color code or highlight selected portions of a chart 252. For example, a user may specify by field, particular data points from particular extractions to be highlighted. Also, if a threshold list is present in the metric set being used for QC charting, the user may select to highlight or color code those data points that are outside of the threshold limit(s) and/or those data points that are within limits. Further, the user may select to display data points using different shapes/icons/graphical representations. For example, the user may choose to display data from different types of extractions within a field by different shapes. Also, the user may choose to display data points that exceed a threshold limit by a first shape (e.g., triangle) and those data points that are within limits by another shape (e.g., circle), e.g., see FIGS. 12A and 13. The system may also display vertical lines (not shown) on QC chart 250 to delineate between different values for a parameter used to order the X-axis. For example, if the user is based on a color/channel mode to separate single channel/color extractions from two color/channel extractions, a vertical line may be displayed to mark the transition from one color extractions to two color extractions.

FIG. 12B shows an example of a QC chart interface 170 that may be displayed in user interface 120 or 30 for example to set up a chart 252 to be plotted in QC chart 250 in a manner desired by a user. The metric set to be used for creating chart 252 can be selected from a drop down menu at window 171.

Specifications of the metrics contained in the selected metric set are displayed in table 172. The extraction query that was used to generate the selected metric set is displayed in window 173. A metric set may be tied to an extraction query with regard to those extractions that were used to generate the thresholds in the metric set. Once the thresholds have been set, the user can apply the metric set with thresholds to any extractions that he/she wants to evaluate with the metric set, by way of additional extraction queries. Accordingly, a drop down menu is provided in FIG. 12B for selection of such extraction queries 173. Sorting of the order in which extractions are to be displayed along the X-axis of chart 252 can be specified at 174, and coloring and shape representation can be specified at 175 and 176, respectively. By selecting button 177, the user can view the chart with the current settings and then go back into interface 170 to change one or more settings to alter the view if desired. In addition, by checking box 178, as shown in FIG. 12B, the values will be color- and shape-coded depending upon whether they are inside or outside of a threshold limit or range. By selecting button 177, the user can view the chart 252 with the current settings and then go back into interface 170 to change one or more settings to alter the view if desired.

In FIG. 12C, table 172 shows that a metric that uses a derivative function of two global statistics has been added to the metric set “10_Apr_Test”. Also, the user has chosen to differentiate extractions belonging to different experiments by different colors (see 175), and to use different shape indicators for data points belonging to different projects (see 176).

FIG. 12D shows the same charts 252 as plotted in FIG. 12A, but where the inliers (as determined by threshold) have been interconnected by a first set of straight lines 251i and the outliers have been connected by a second set of straight lines 251o. Line sets 251i and 251o may also be differentially color-coded. Alternatively, the points may be connected by one line, which is color coded in a point-to-pint manner, depending upon whether or not the values are inside or outside of a threshold.

FIG. 15 shows a chart 252 plotted after user selected settings (described above) have been set. The global statistics plotted are for the metric measuring non-uniform features of any color (i.e., “AnyColorFeatNonUnif”) and this chart was selected to be plotted separately, as the only plot 252 on QC chart 250. The X-axis ordering in this example is according to barcode label identification numbers in ascending order, and barcode label identification numbers were selected to be displayed along the X-axis to identify the extractions. In this example, data points were colored according to scan dates of the extractions from which the data points were taken, with data points 252r from extractions having a first scan date color coded red, data points 252b from extractions have a second scan date color coded blue and data points 252y from extractions having a third scan date colored yellow. The data points are also displayed with shapes to distinguish control samples from test sample, by a circular shape and a triangular shape, respectively.

Each X-axis location displays only one data point (one extraction) in FIG. 15. FIG. 13 shows the same data grouped by scan date and type/description (control or test).

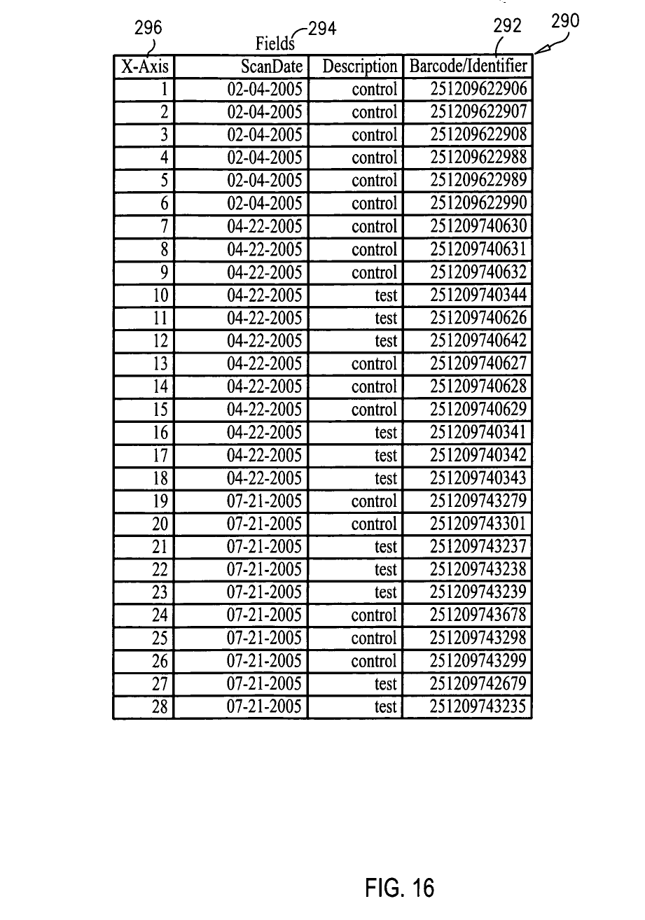

A query table 290 may also be displayed with QC chart 250 (either along side, or on a separate page). An example of query table is shown in FIG. 16.

Query table 290 may correlate the X-axis positions 296 with the barcode or other unique identifier 292 associated with the extraction from which the data point appearing in that location was taken, and the fields 294 that were selected to query the data. Fields 294 may be displayed in the order that was selected for grouping and/or ordering along the X-axis. Alternatively all array processing parameters (and, further optionally, all user annotation fields) may be displayed in query table 290 to assist the user in reformulating/editing the query.

As noted above, once a QC chart 250 is in view, the user can visually review the plot(s) 252. If thresholds are plotted, these can assist the user in visually determining which data points may be out of the set limits and which therefore may need further review. Even without thresholds, the user may be able to identify data points that may be outliers and thus identify extractions that may need further review/evaluation. For example, in FIG. 15, the user may question data point 252re regardless of whether or not a threshold is displayed. As already noted, by clicking on data point 252re, the retrospective system via interface 120 or FE tool 20 via interface 30 can display statistics table 210 with the row containing data for the extraction from which data point 252re was taken being highlighted to facilitate the user's further review.

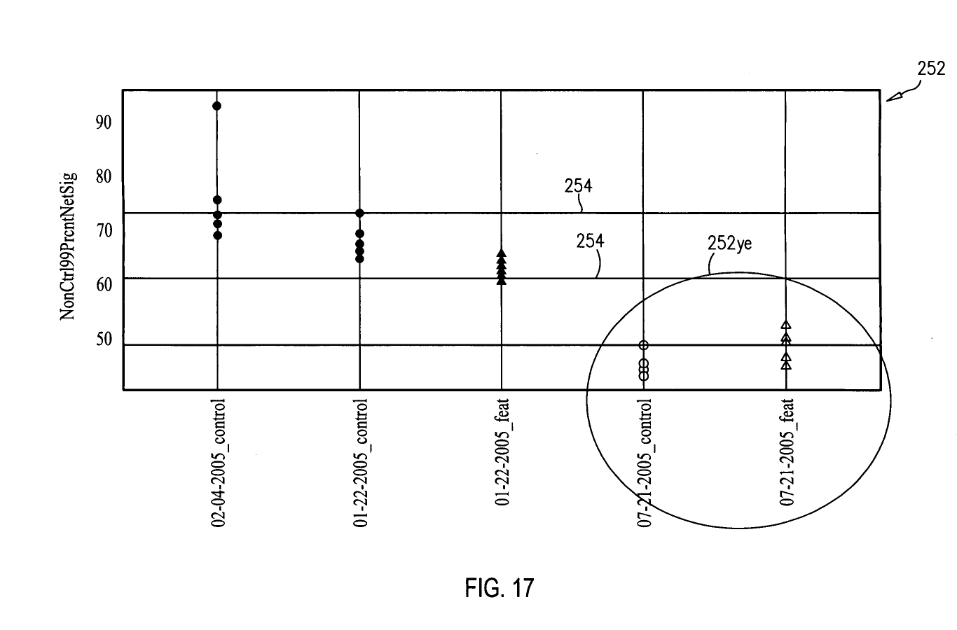

FIG. 17 shows a chart 252 in which global statistics for the net signals for non control red features were plotted, with data from extractions being grouped by scan date and type/description (i.e., control or test) along the X-axis. In this chart 252 it can be readily observed that all of the data from the third scan date (identified by 252ye in FIG. 17) appears to have low signal metrics as being out of the range or close to the range defined by thresholds 254. In this case, the user may choose to click on one of the data points in question to review these extractions in further detail in the statistics table 210 in a manner as described above. Alternatively, or additionally, the user may modify the query to run and display a different QC chart. For example, the user may run and display a chart 252 to plot against a different go metric, without changing any of the other criteria. Alternatively, the user may decide to change the X-axis layout so that only a single data point is shown in each X-axis location and set via the barcode identifiers of each data point in 252re to highlight the data points corresponding to those barcode identifiers as displayed in the new chart 252, and then run the chart of the different metric referred to above. By reviewing the resultant chart 252, the user can assess whether the potential outliers 252re in the first chart 252, showing one metric (FIG. 15) are also potential outliers in the second chart 252 (see FIG. 17 showing a second metric), i.e., if they are correlated across different metrics. Alternatively, both metrics can be shown in a stacked QC chart 250, to make cross-correlation of highlighted data points easier to view.

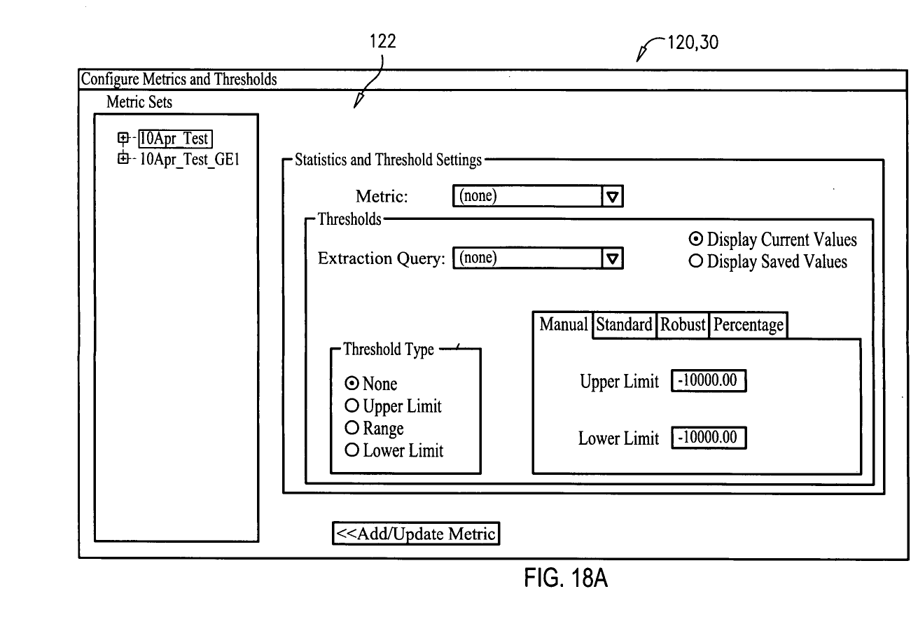

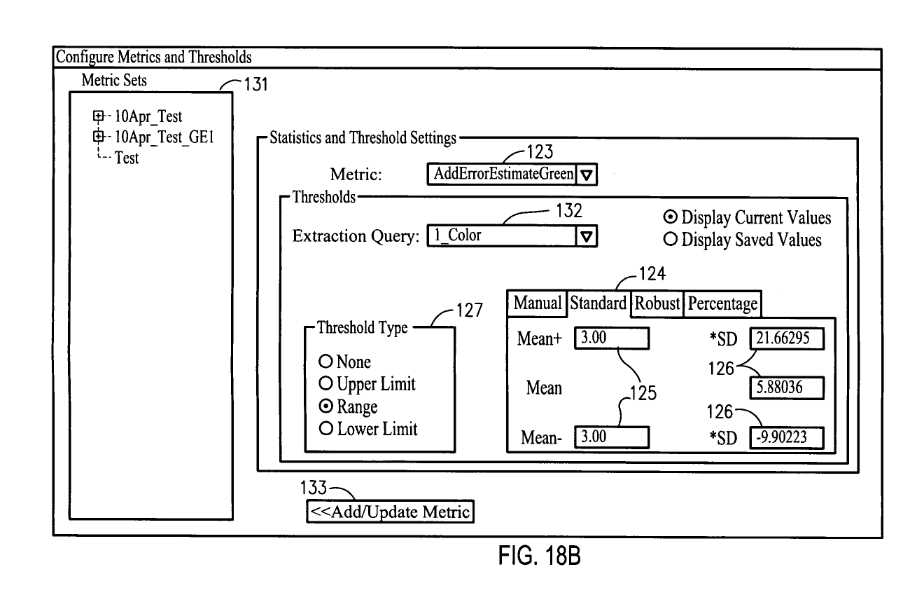

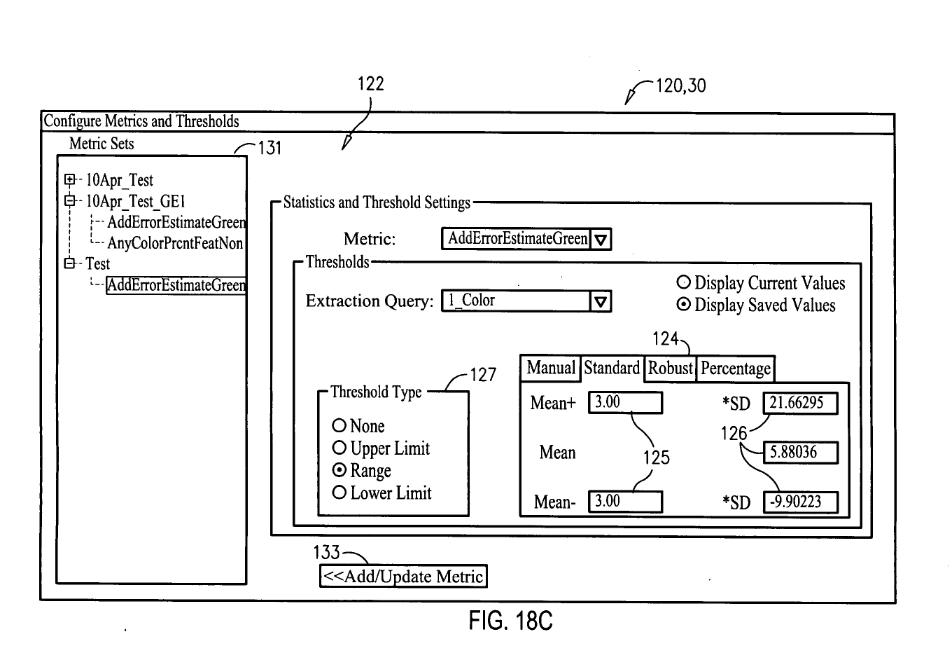

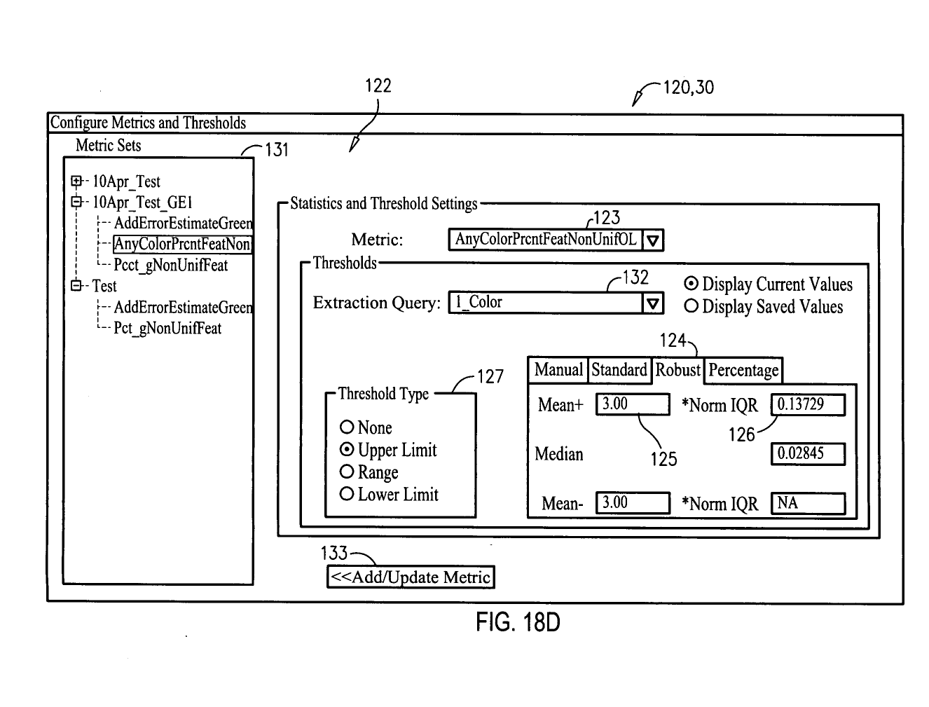

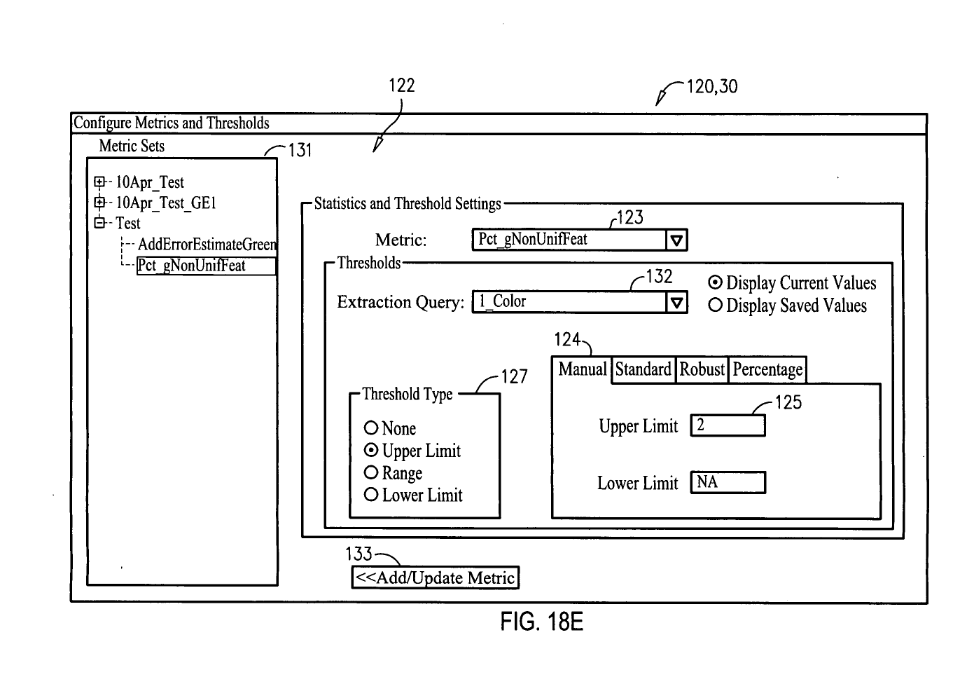

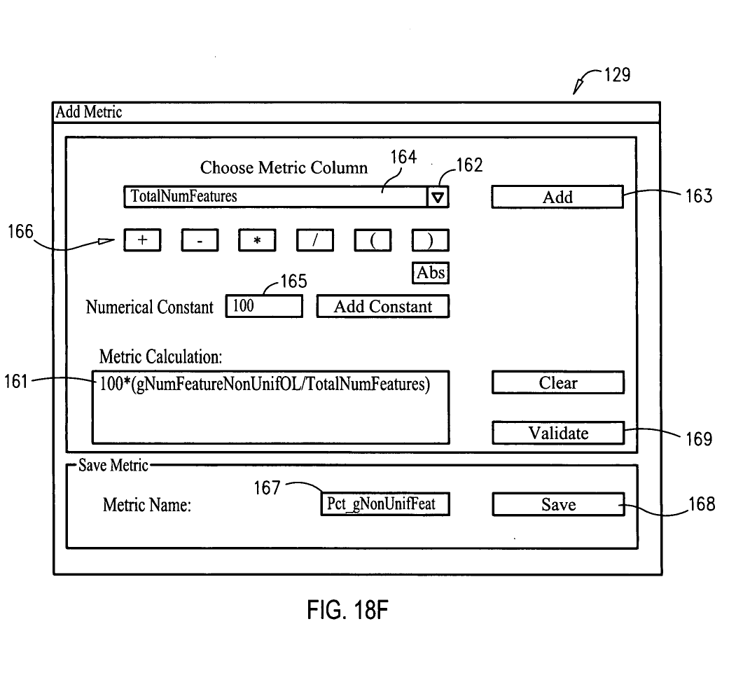

Once a metric set is set up by a user, either with or without thresholds, a QC chart 250 can be produced by pointing to the desired metric set and extraction set desired to be plotted. At this time, the user may return to the metric set by displaying the metric set in user interface 120 or 30 to calculate summary statistics to make into thresholds, if desired. FIG. 18A shows a metric sets user interface 122 that can be called to display in user interface 120 or 30 for set up of metric sets as described. Metric sets user interface 122 provides interactive features from which the user may make selections. In the example of FIG. 18B, the user has selected to make a new metric set called “Test” as indicated in the metric sets table 131. The user has selected to add the metric “AddErrorEstimateGreen” to the metric set, as indicated in box 123, as selected from a drop down menu when the arrow at the right side of box 123 is clicked on. The extraction query (in this instance, “1_Color”) that is associated with this metric is indicated in box 132, and is selectable in the same manner that the metric is selected in box 123. Feature 127 allows the user to select the type of threshold, e.g., from the choices “None”, “Upper Limit”, “Range” and “Lower Limit”. Feature 124 includes tabs that allow the user to choose among various types of statistics for calculation of thresholds, including “Manual”, “Standard”, “Robust” and “Percentage”. In the example of FIG. 18B, the user has selected standard statistics. Feature 125 allows input of a multiplier to be used for calculating a summary statistic. In the example of FIG. 18B, the user has inputted “3” as a multiplier, and, since standard statistics were selected, the derivative statistics “Mean+3*standard deviation” and “Mean−3*standard deviation” are calculated by retrospective tool 105. As a result of the selections made in features 123, 124, 125, and 127, standard summary statistics are calculated for both upper and lower limits from the data point values in extractions resulting from the extraction query 132 are displayed in windows 126. Alternatively, all available statistics (standard and robust) may be displayed in window 126, with the selected statistics being shown in bold and the statistics not selected (robust and derivative robust, in the example of FIG. 18A) grayed out, or on different tabs as in the example shown in FIG. 18B, 124. These statistics may be saved in a text file in database 100 as part of the metric set. After the new metric, created as described, is added to the metric set (e.g., metric set “Test” in this example) by clicking on the “Add/Update Metric” button 133, its threshold settings 125, 126 and 127 are shown as saved values and are not editable by a user, see FIG. 18C where these values have been grayed out.

For setting thresholds, the type of threshold to set will depend upon which metric is being evaluated. As noted above, thresholds may include a lower limit, an upper limit, or both an upper and lower limit to establish a range of values. Using the metric interface feature 122, the user can select which limit or limits to use for a threshold for the particular metric/chart displayed in feature 123. For example, in FIG. 18B, the user has selected a “range” threshold type to be calculated, via radio buttons at 127, yielding an upper limit of “Mean+3*SD” and a lower limit of “Mean−3*SD”. Alternatively, a user may select limit choices at 125 and once one or more limit choices are selected, retrospective tool 105 may determine from the selection(s) what type of threshold has been selected and automatically select the type of threshold selected in the listing of threshold types 127. FIG. 18D shows an example where the user has chosen robust statistics. In this example, the user has chose to add the metric “AnyColorPrcntFeatNonUnifOL” (see 123) to the metric set called “10Apr_Test_GE1” as shown in the metric set table 131 with the current metric to be added being highlighted. The extraction query 132 is the same that was chosen in the previous example. For this metric, an upper limit threshold was chosen at 127 and the robust statistic was set at “Median+3.00*Norm IQR, see 125. The resulting summary statistic for this extraction query is shown in box 126. Once the user is satisfied with the types of statistics to be used and the threshold settings, these setting may be saved by clicking the “Add/Update Metric button 133.

FIG. 18E shows an example where the user has chosen manual statistics at 124. In this case the user has selected to input an upper limit (see 127) threshold value and has inputted an upper limit value of “2” in box 125. In this example, the metric “Pct_gNonUnifFeat” (see 123) has been selected to be added to the metric set called “Test” as shown in the metric set table 131 with the current metric to be added being highlighted. The extraction query 132 is the same that was chosen in the previous examples. Once the user is satisfied with the types of statistics to be used and the threshold settings, these setting may be saved by clicking the “Add/Update Metric button 133.

The drop down menu in box 123 allows the creating of new metrics to be shown in the selection. These metrics may simply be global statistics, already calculated by feature extraction tool 20, or they may also be new derived metrics, defined by the user. Alternatively, the metric can be based upon a user-added annotation, such as a metric of sample quality, for example. By selecting the “Add New” choice in this drop down box 123, means to add a new metric to the metric set being edited is provided. Upon selecting the “Add New” choice, an Add Metric feature or window 129 is displayed in the metric set interface, e.g., on user interface 120. A screen shot of the Add Metric feature/window/interface 129 is shown in FIG. 18F. In this example the user is defining a new metric that is a derivative of two existing metrics (i.e., “gNumFeatureNonUnifOL” and “TotalNumFeatures”) The existing metric can be added to the function displayed in the metric calculation window 161 by selecting them from a drop down menu 162 and selecting the Add button 163 when the metric that is desired to be added appears in the window 164. A numerical constant may be inputted by the user at 165. Functional operators 166 may be selected at 166 to define the relationships between the terms in the metric calculation. The new metric can be named by the user at 167 and saved by clicking on the save button 168. Additionally, the software may provide a “validate” function, which may be displayed for selection as validate button 169. Upon selection of button 169, this prompts the software to first check the validity of the user expression. The validate function checks validity by parsing the expression and making sure that it is not logically contradictory in the context of the metric interface and, for example, does not use strings when numeric values are required. For example, an expression such as “(x/y)*100” will be validated, as it is mathematically and logically correct, whereas an expression such as “*x/y100” will fail validation and therefore not be saved into database 100.

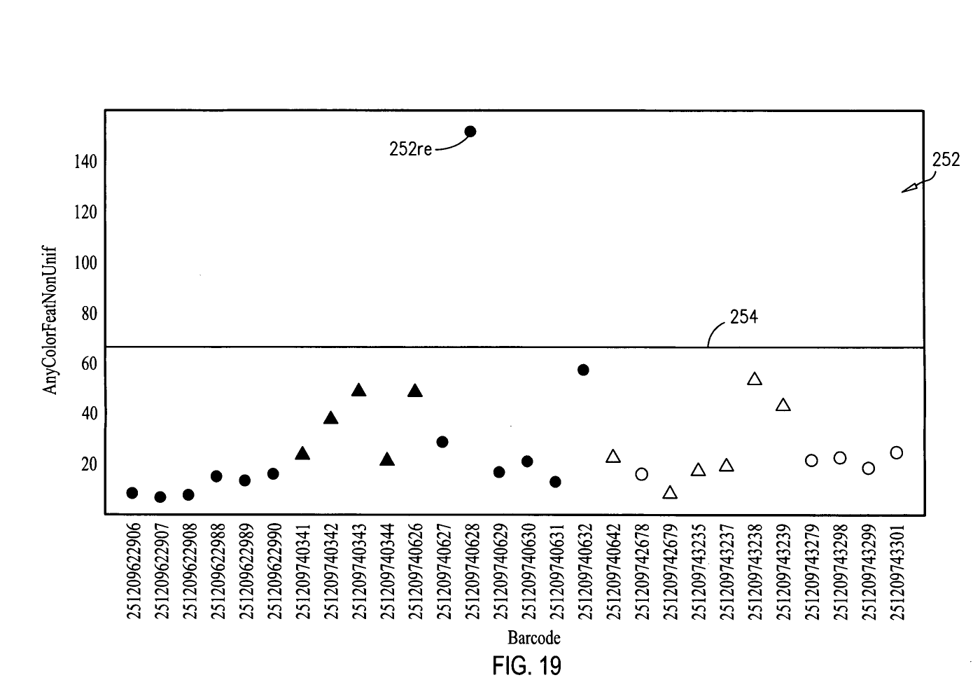

Upon reviewing the charts 252 against the thresholds and statistics as set, the user may decide to edit the extractions that are being used to calculate the statistics. For example, if chart 252 in FIG. 15 shows the data from extractions being used to calculate summary statistics and thresholds. After reviewing this plot, the user may want to exclude the extraction from which data point 252re originated, as it appears to be a possible outlier. Accordingly, the user may reformulate the query to exclude the unique identifier (e.g., barcode identifier or other unique identifier) and thereby exclude data point 252re in the calculations of statistics and thresholds. For example, the following statistics were calculated using all of the data points shown in FIG. 15: Mean=29.1, Standard Deviation (SD)=27.8, Mean+3*SD=112.5. After modifying the query so as to include all data points except data point 252re, the statistic values were calculated to be as follows: Mean=24.6, Standard Deviation (SD)=14.5, Mean+3*SD=68.1. FIG. 19 shows a plot of chart 252 of the same metric and data points shown in FIG. 15, and with an upper threshold limit 254 plotted, wherein the upper threshold limit was calculated from all data points except data point 252re in FIG. 15. The barcode identifiers along the X-axis may be color coded. For example, in this case, the barcode identifiers may be color-coded blue if their corresponding data point values were less than the upper limit threshold value, or pink, if their corresponding data point values were greater than the upper limit threshold. Viewing of chart 252 can assist the user in deciding to leave out the extraction from which data point 252re was taken when calculating summary statistics for this metric.

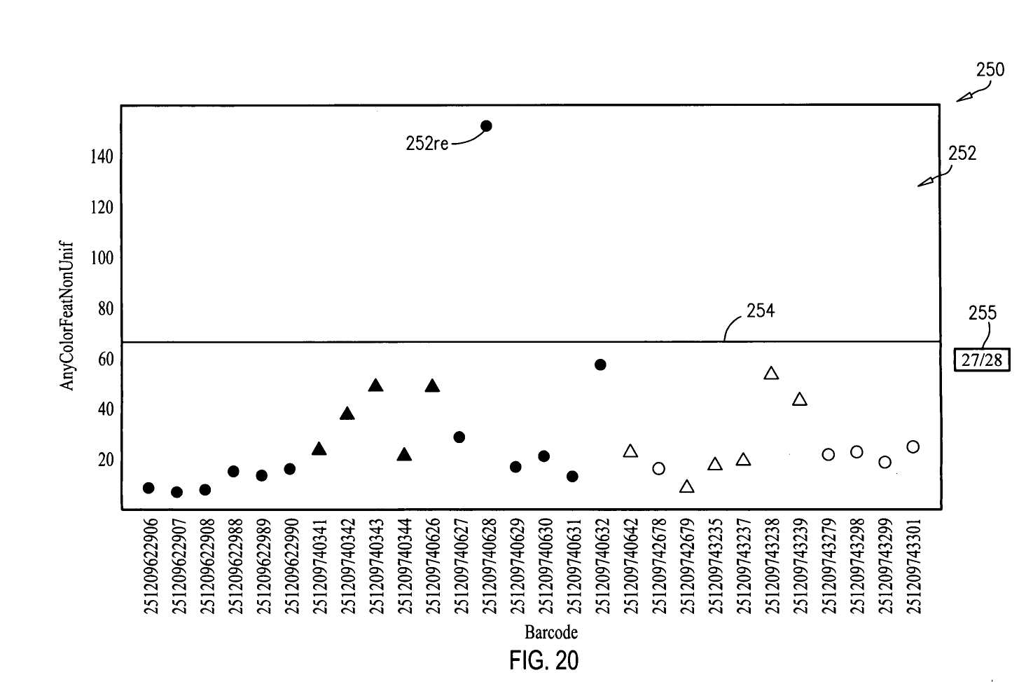

When threshold(s) is/are displayed on a chart 252, then the number of extractions (data points) that are within limits may be counted and displayed relative to the total number of data points displayed, as shown in threshold evaluation box 255 in FIG. 20. This feature may be used to review the performance of thresholds. For example, if a chart 252 for a metric consistently shows most extractions (over different batch runs, for example) as not within the limits of the threshold 254, then the threshold may be set too “tight” (too restrictively) and may need to be modified. On the other hand, if extraction data is rarely observed to exceed the threshold limit(s), then the threshold may need to be tightened.

For QC charts 250 that include stacked charts 252 (like shown in FIG. 10, for example) the number of metrics that are within range for each extraction may be displayed (optionally the total number of metrics may be displayed along side, for reference) adjacent each extraction identifier along the X-axis beneath the lowest-displayed chart 252.

The processes of querying and setting threshold and/or preferences can be iterative, as described, and an edit button may be provided on QC chart 250 that, when selected by a user, allows the user to re-execute and display QC chart 250 after changing a query, threshold, or preference in a manner as described above.

Uses

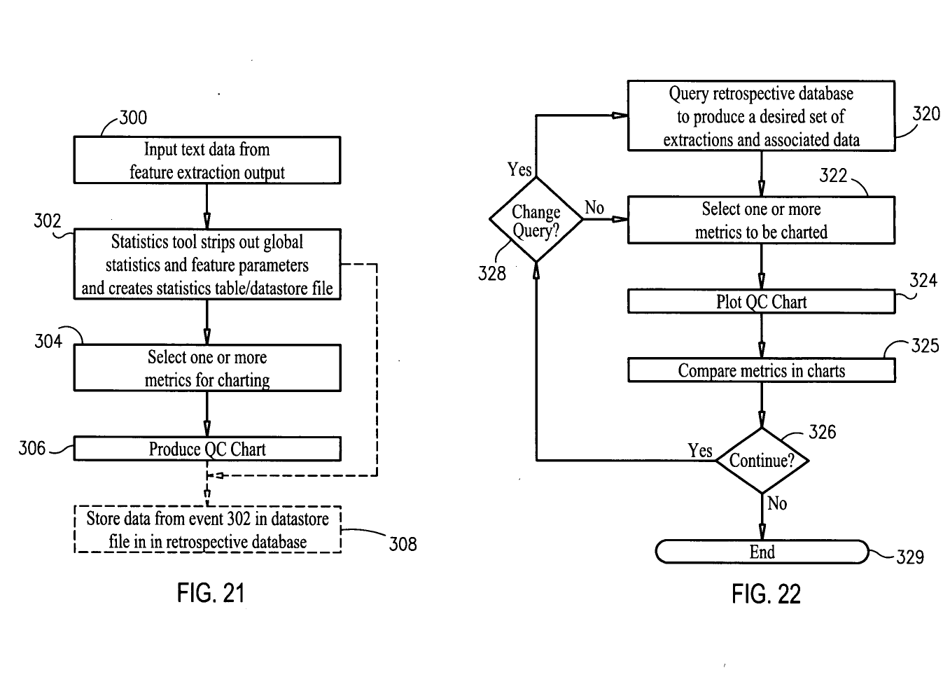

The retrospective system may be used as a standalone system or may be integrated with a feature extraction system, as noted above. In one embodiment, retrospective system may be used to facilitate a cross comparison of global statistics calculated by the feature extraction system with regard to a set of global metrics used to characterize feature extraction results. FIG. 21 illustrates a flow of events that may be carried out according to one embodiment of use described here. At event 300 feature extraction output 22 is inputted to the retrospective system, e.g., the retrospective tool 105. Feature extraction output 22 contains array processing parameters, global statistics and feature data for each extraction, as previously described. Feature extraction output 22 may be inputted to retrospective tool 105 automatically when it is output from feature extraction tool 20 in embodiments where the retrospective system is integrated with the feature extraction system, or may be inputted manually when the retrospective system is a stand alone embodiment, such as by a user pointing to a text file that contains feature extraction output 22, for example. FIG. 6A shows a screen shot of a statistics table interface 135 displayed on user interface 120 in preparation for generating statistics table 210. In this instance, no extractions are currently contained in statistics table 210 using the extraction query “All”.

At event 302, statistics tool 130 of retrospective tool 105 strips out the global statistics and array processing parameters for each extraction reported in feature extraction output 22 and creates statistics table 210/DataStore file using this information. At this stage, retrospective tool may be used by a user to more easily compare global statistics across extractions in the batch by displaying table 210 on user interface 120, as table 210 contains global statistics for all the extractions in a single table, organized in columns, for easy comparison, see FIG. 6. Note, however, that user annotations will not be added to the statistics table at this stage, as has already been described above. FIG. 6B shows a screen shot of a partial view of statistics table 210 after loading a first set of extractions and making initial extraction queries. The data displayed are associated with the extractions that are considered as a result of the extraction queries made. Each extraction produces a row in the table 210 with associated array processing parameters and global statistics from the feature extraction output 22. The extractions tab 137, within the extraction results section 136, has one or more extraction queries. By selecting the extractions tab 137 and selecting an extraction query listed therein (such as “All”, or some other extraction query, for example), statistic table 210 displays the extractions and array processing parameters, global statistics and any user annotations associated with those extractions. The results from this extraction query may then be used by the QC Chart interface 170 to generate a QC chart.

Extractions can be loaded into the statistic table either individually or recursively among several layers of folders, for example. FIG. 6C shows a screen shot where the user has selected to recursively load extractions from a series of folders, by selecting the recursive import feature 139. A browser feature 141 is provided in the statistics table interface 135 that allows a user to select folders from which to import data from extractions into statistics table 210, see FIG. 6D. All extractions contained within the folder (and any subfolders) of the folder selected (as shown highlighted) are extracted and the data extracted therefrom is added to statistics table 210 as statistics tool 130 recursively goes through the files in the selected folder and any subfolders present.

A browse feature 143 is provided in the statistics table interface 135 that allows a user to select files from which to import user annotations into statistics table 210, see FIG. 6E. Upon selecting the locations of a file or files containing user annotations that can be linked to specific extractions in a manner as described above, statistics tool 130 imports the user annotations and appends them to the appropriate extraction records as described above. This linkage may be performed, for example, by matching the barcode identifier associated with an extraction in the data store 100 with the barcode identifier associated with one or more user annotations in the user's annotation file. In addition, a second or more field(s) may be used to identify an extraction uniquely. For instance, an array may have been scanned more than once. For such a situation, a combination of a barcode identifier and scan date/time may provide one example of a unique identifier that can be used. An extraction query may be performed to find all extractions that have not been user annotated in a manner that a user might desire. FIG. 6F is a screen shot of an extraction query builder feature in extraction query interface 145 displayed on user interface 120. Using this feature, the column name 146 of the user annotation name for that column of data in the statistics table 210 is selected. By selecting “IS NULL” in the operator box 147, the user has chose the extraction query to look for all extractions for which there is no user annotation entry for “Project”. Other operators that may be selected by a drop down menu include “equals”, “contains”, etc. The extraction query as constructed is displayed in the extraction query box 148. Additional column names and operators may be appended to the extraction query using the buttons 149 and iterating the selection of column name and operator for another user annotation. A name for the extraction query assembled can be inputted in box 151 that may be used for such purpose. The query may be saved, as already previously described, by selecting either the “Save” or “Save As” button 153a, 153b, respectively. By clicking on “Show Results” 154, a list of the extractions meeting the specifications of the extraction query are displayed. Additionally, the software may provide a function to perform verification that the user extraction query is correct, and this function may be executed by selecting the “Verify” button 155 (see FIG. 6F). FIG. 6G shows a screen shot of extractions displayed in statistics table 210. Overlaid on this display is extraction query interface 145 showing that a user desired to run an extraction query to find all extractions that have the user annotation “GreenSample” that include the term “brain”, as indicated in the extraction query interface 145 shown. The statistics table in FIG. 6G contains 237 extractions prior to running the extraction query shown. Upon clicking the show results button 154, statistics table 210 displays two extractions that meet the criteria of the extraction query, as shown in FIG. 6H superimposed on the extraction query results.

To provide perhaps an even easier, more visual comparison of the global statistics values, the user may choose to plot the global statistics of one or more selected values in one or more charts 252 in a QC chart. By selecting the metrics to be charted at event 304, and running the QC chart tool 140 of retrospective tool 105, the user is provided with a visualization of QC chart 250 on the user interface at event 306. It should be noted that, of course, any visualization provided on user interface may also be outputted as a hard copy on paper or other medium for review, transmitted electronically, etc.

In addition or alternative to performing events 304 and 306 (FIG. 21), when the retrospective system is not integrated with a feature extraction system and thus feature extraction output data is manually inputted to the retrospective system, the information used to create statistics table 210 at event 302 may be stored in the DataStore file in retrospective database 100. That is, the user defined metric sets, extraction queries, and QC chart preferences can be saved to retrospective database 100. The information from event 302 is added to the DataStore file. If there is already information existing in the DataStore file from previous extractions, the information from event 302 is added to the existing data in the DataStore file. The user may iterate steps 304 and 306 as many times as desired, while changing metrics to be displayed in QC Chart 250. Also, the user may query the statistics table/DataStore file containing the data from the extractions from event 300 to display data from only a subset of the extractions contained therein. The order in which the data from extractions are plotted along the X-axis in charts 252 may be sorted, as described above.

The events 300-308 may also be carried out by the feature extraction system using feature extraction tool 20 and user interface 30, such as when retrospective tool 105 is integrated in the feature extraction system and a metric set is imported from retrospective database 100 to feature extraction database 10 and linked to a feature extraction protocol or to a feature extraction project and used in creating QC chart 250. At event 300 feature extraction output 22 created by feature extraction tool is used at event 302, where feature extraction tool strips out the global statistics and array processing parameters for each extraction reported in feature extraction output 22 and creates statistics table 210 using this information. At this stage, feature extraction user interface 30 and feature extraction tool 20 may be used by a user to more easily compare global statistics across extractions in the batch by displaying table 210 on user interface 30, as table 210 contains global statistics for all the extractions in a single table, organized in columns, for easy comparison, see FIG. 6. Note, however, that user annotations will not be added to the statistics table at this stage, as has already been described above. However, feature extraction user interface 30 may be configured to add user annotations to statistics table 210, using feature extraction tool 20 in a similar manner to that described above when using interface 120 and retrospective tool 105.

To provide perhaps an even easier, more visual comparison of the global statistics values, the user may choose to plot the global statistics of one or more selected values in one or more charts 252 in a QC chart. By selecting the metrics to be charted at event 304, and running the QC chart tool 140 of retrospective tool 105, the user is provided with a visualization of QC chart 250 on the user interface 30 at event 306. It should be noted that, of course, any visualization provided on user interface may also be outputted as a hard copy on paper or other medium for review, transmitted electronically, etc.

In addition or alternative to performing events 304 and 306, a batch of extractions used to create statistics table 210 at event 302, may be exported to retrospective database 100. The information from event 302 is added to the DataStore file. If there is already information existing in the DataStore file from previous extractions, the information from event 302 is added to the existing data in the DataStore file. The user may iterate steps 304 and 306 as many times as desired, while changing metrics to be displayed in QC Chart 250. Also, the user may query the statistics table containing the data from the extractions from event 300 to display data from only a subset of the extractions contained therein. The order in which the data from extractions are plotted along the X-axis in charts 252 may be sorted, as described above.

A user may perform events 300-306 with retrospective tool for a batch of extractions that were feature extracted by a feature extraction system to easily visually compare metrics of all the extractions with one another. For example, if a user runs an experiment on forty arrays and expects to get substantially the same results for each extraction, by executing events 300-306 for several metrics, the user can readily compare the global statistics of all forty extractions on QC chart 250 for the metrics selected to facilitate identifying and selecting extractions that show one or more global statistics that are not generally similar to the same statistics for the majority of the extractions. In this way, a user can quickly decide which extraction data can be sent to a downstream software package for further analysis and processing of the data, and which extractions may need to be more closely examined before sending their data downstream or rejecting one or more of those extractions. This decision making process can also be performed automatically by the retrospective system or by the feature extraction software when thresholds are employed, as will be described in another example of use below.

As another option, events 300-308 may be executed iteratively, where data inputted at event 300 may be from different batch extractions with each iteration. In this case, the charts 252 plotted in QC chart 250 will plot increasingly more data points with each iteration, as all extractions will be included from the DataStore file for use in producing the charts 210 and data from additional extractions (another batch) are added to the DataStore file with each iteration.

FIG. 22 illustrates events that may be carried out to perform tasks similar to those described with regard to FIG. 21, but where data from extractions that are stored in retrospective database are used in the process as obtained by querying database 100. As with the processes described with regard to FIG. 21, a set of extraction data from extractions being currently evaluated by the system may be included in the set of extractions processed here, as statistics tool may add the current data to the DataStore file immediately upon extracting the data from the batch of feature extraction outputs 22. Alternatively, these events may be carried out solely on the basis of existing data in the database 100. At event 320, database 100 is queried with an extraction query in a manner as described above, to obtain a set of extractions and associated data to be further processed. The query may be formulated so as to compare only data having the same or similar processing constraints, so that the user expects all of the global statistics to be about the same, like described above with regard to FIG. 21. Alternatively, the query may be formulated to include extractions where one or more processing constraints have been changed, so that the user can compare results between processes, to see if they have any impact on the resulting global statistics. Different processing may include, but is not limited to: varying sample preparation and labeling, varying hybridization and wash conditions, varying scanning parameters, and/or varying one or more feature extraction parameters.

At event 322, one or more metrics are selected by choosing a metric set for which charts are to be plotted, and the resulting plots are plotted in QC chart 250 at event 324. The user may then compare the metrics 325 among the extractions plotted in each chart to note significant differences, for further review of those extractions that appear to show significant differences. In the case where the user expects all extractions to show similar statistics, the user may want to review those with differences to see whether or not those extractions should be discarded. In the case where the user is looking at extractions where different sets have used a different processing parameter than the others, then a user may want to further analyze the extractions showing the different results to see if they are correlated with the change in processing parameter.

After comparisons have been satisfactorily completed, the user may be given the option to iteratively process the data at event 326. If the user chooses not to continue processing, the processing ends (event 329). If the user chooses to continue processing, then the user is given an option to change the query (event 328). By changing the query, the user can alter the set of extractions and associated data to be plotted in the next iteration of charts. For example, if the extractions in the previous iterations included one set processed under a hybridization condition A and a second set having a hybridization condition B, the user may want to alter the query to obtain a set of extractions proceeds under a hybridization condition C, for comparison with one or both sets of extractions processed under conditions A and B, respectively. Alternatively, the user may choose not to change the query with this iteration, but to alter the metrics that are to be plotted as charts at event 322.

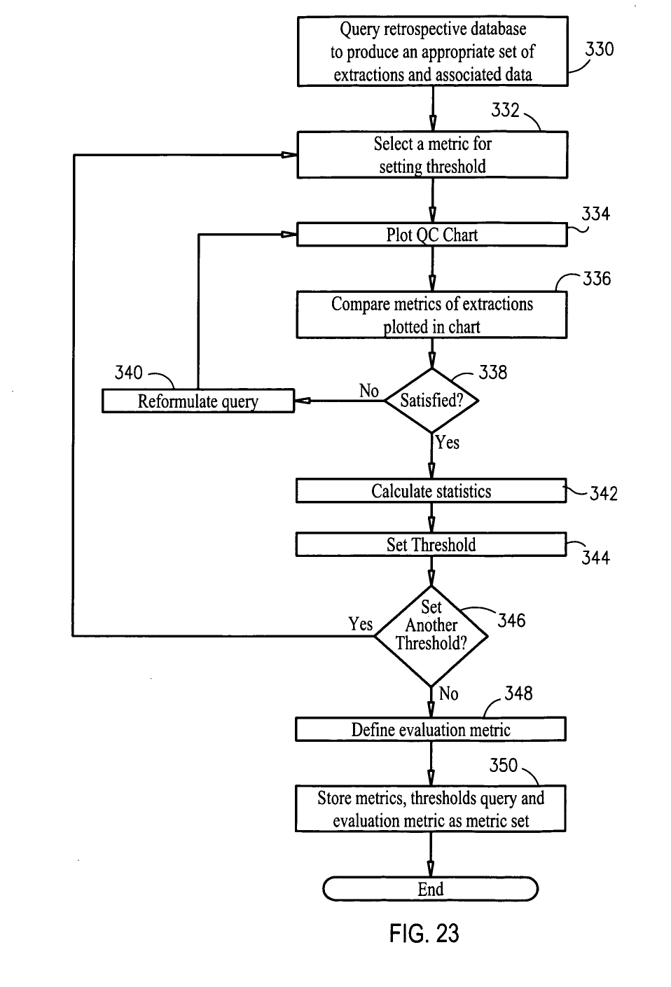

FIG. 23 illustrates events that may be carried out by the retrospective system when used for setting thresholds. At event 330, retrospective database 100 is queried with an extraction query to obtain a set of extractions that the user may define through any of the user settable query terms that were described above, that the user believes will adequately narrow the set of extractions to extractions that are similar to extractions to be evaluated using the thresholds derived from the query results. This process may also be run with the process described in FIG. 21, so that the extraction data from a batch of extractions to be evaluated may be included in the extractions used to set one or more thresholds.

At event 332 a metric is selected for which it is desired to set a threshold and a chart 252 of the global statistics for that metric from the set of extractions is plotted at event 334. The user may wish to visually compare the metrics of the various extractions plotted in the chart 252 at event 336 to identify potential outliers that the user may want to remove prior to calculating a threshold. At event 338 the user is given an option to reformulate the query to remove any extractions that the user might believe would skew the statistics for setting a threshold (e.g., potential outliers). For example, the user may reformulate the query (event 340) to specifically exclude a particular extraction by unique identifier, or may want to exclude a group of extractions by some common array processing parameter or user annotation that they share, when all are perceived as potentially skewing the statistics. If the query is resubmitted to define a different set of extractions, then chart 252 is re-plotted at event 334 for the same metric previously selected, and events 336 and 338 are repeated. Once the user is satisfied with the chart results of the current extraction set, then summary statistics are calculated at event 342 to characterize the distribution of the metrics plotted in chart 252. These summary statistics may be standard statistics or robust statistics, as was described in more detail above. The user may next set a threshold at event 344 using the summary statistics that were calculated or by manually setting a threshold, in any of the manners described previously.

At event 346, the user may set another threshold by returning to event 332 and selecting a different metric to repeat the further events for setting a threshold for that metric. Once all of the thresholds that were desired to be set have been set, the user may define an evaluation metric at event based upon the metrics for which thresholds have been set. At event 350, the metrics, thresholds, extraction queries and evaluation metric may be saved in retrospective database 100 as a metric set. Note that the extraction queries and hence the extraction sets may be different for different metrics within the same metric set, but by saving date stamped queries for each metric and threshold, the extraction sets can be reliably identified at a later date, if needed. In embodiments where the feature extraction system is integrated with the retrospective system, the feature extraction system can access a metric set through linkage with the feature extraction protocol, and apply it to feature extraction outputs to evaluate metrics of individual extractions in the feature extraction outputs.

A metric set may be substituted for the metric selection events 304 and 322 in the processes described above with regard to FIGS. 21 and 22. This can be done if a user is manually, interactively processing data, or may be done so that the retrospective system can automatically evaluate the extraction data using the thresholds contained within the metric set. These methods may be used to evaluate a new array processing kit, for example, where the new kit may employ one or more different process conditions than extractions performed with an old processing kit. By comparing metrics from feature extraction results of extractions performed on arrays processed with the new kit to metrics from feature extraction results of extractions performed on similar arrays processed with the old kit determinations can be made as to whether the results from the new kit are satisfactory, or are superior or inferior to those of the old kit.

These methods may also be used as a training or quality control tool. For example, if a new technician begins processing arrays, the metrics from feature extraction results of extractions performed on arrays processed by the new technician can be compared with feature extraction results of extractions performed on similar arrays processed by other existing technicians that have a history of satisfactory processing, to determine whether the new technician is producing satisfactory results. The same types of comparisons may be made with regard to arrays processed by an inexperienced technician to provide feedback as to when his or her results are improving, relative to the standards set by experienced technicians.

Further, these methods may be used for product development. For example a change may be made in an array type, type of scanner used, hybridization conditions, extraction algorithms, etc. and the metrics from feature extraction results of extractions performed on the arrays in which a change has been made can be compared with feature extraction results of extractions performed on arrays in which the change has not been made to determine whether the change has had a positive or negative (or no) impact on the results obtained. These comparisons can thus help guide the developer to incorporating only those changes that have a positive impact on the extraction outputs.

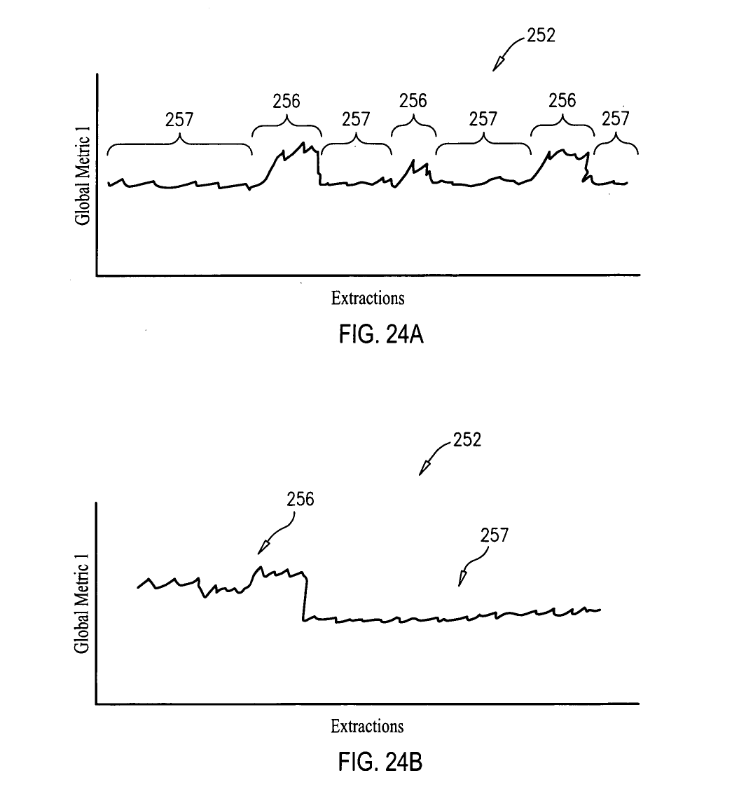

Another use of the methods described herein is for diagnosis or “trouble-shooting” of process-induced errors or variations in feature extraction outputs. For example, metrics of feature extraction results from similar arrays may be monitored over time using the techniques described herein. As new batches of arrays are feature extracted and the global statistics of these extractions are added to retrospective database 100, each subsequent QC chart produced includes a greater population of extraction statistics to be plotted. At some time, a user may start to notice that some of the metrics plotted in one or more charts 252 have varied significantly from the average or median summary statistics expected. FIG. 24A illustrates a chart 252 where some such changes are apparent. Upon viewing a chart such as chart 252 shown in FIG. 24A, a user may attempt to sort the extraction data points so that those data points 256 that vary significantly from the data points 257 having values within the normal range expected are grouped separately from those data points 257 within the normal range, as illustrated in FIG. 24B. If the user can reformulate a query on the extractions plotted in FIG. 24A or sort the data in FIG. 24A to achieve a plot that substantially separates the values 256 from 257, then the criteria (array processing parameter and/or user annotation) that was/were used as a basis for rearranging the data as shown in FIG. 24B can be assumed to be the reason for the straying of data values. Alternatively, the retrospective tool 105 may provide statistical algorithms to find parameters that best define the two clusters of data. Thus, for example, if the extractions in FIG. 24A are ordered in FIG. 24B according to the specific scanner used, it might be determined that scanner number 3 needs to be recalibrated, as the outputs for this metric that are labeled 256 all originated from extractions that were extracted from array images produced by scanner 3, whereas global statistics for this metric that originated from extractions that were extracted from array images produced by scanners 1, 2 and 4 were all within normal values 256.

The more that different types of user annotations are appended to the extractions, the more precise will be the ability of the system to diagnose variations/errors in global statistics. The “system” as used here, refers to either the user discovering the factors that differentiate the data, in combination with use of the retrospective system to provide the data, or to the retrospective tool 105 using statistical algorithms to cluster the data automatically. Further, if the investigator has a hypothesis as to what may be the cause in problems with global statistical values (e.g., the investigator thinks that global statistical values may have started showing significant changes in values when array preparation was changed from room A to room B) and there is a user annotation field or array processing parameter that can distinguish the factor that has changed that the investigator may believe is the cause for the significant changes in global statistics, then the investigator can perform a query configured to sort the extractions according to the factor (array processing parameter or user annotation) that he or she believes is the cause. If that factor is in fact the cause, the metrics plotted in chart 252 will separate among two different classes, such as is illustrated in FIG. 24B. The investigator can investigate by applying these techniques iteratively, each time sorting on a different array processing parameter or user annotation or set thereof, to try and pinpoint a cause of the change in global statistics values.

Because there are so many different variables associated with the feature extraction outputs (e.g., many array processing parameters and variables defined by user annotations), it may be too complicated, in some instances, to diagnose the cause of significantly altered global statistical values by the methods described above. For example, the investigator may not have any idea of what might be causing the change is global statistical values. Further, there may be two or three different feature attributes or variables characterized by user annotation that are causing the significant change in global statistic values. Also, as the number of array processing parameters and user annotations increases, not only does this provide more precision for the ability to diagnose a problem, but it also greatly increases the complexity in the task required to analyze all these array processing parameters and user annotations to attempt to find a correlation to the problem. Accordingly, the retrospective system may include a diagnosis tool 150 that the user may run on the data. Diagnosis tool 150 receives the global statistics data of the extractions being investigated, as well as all of the array processing parameters and user annotations associated with the extractions and performs a correlation analysis to identify those array processing parameters and/or user annotations that are determined to correlate with the significant changes in global statistics values. Diagnosis tool 150 may rank the order of array processing parameters and user annotations from most highly correlated to least correlated and/or may assign correlation scores to the array processing parameters and user annotations and output the rank order and/or correlation scores to be viewed by the investigator via interface 120. The diagnosis tool 150 may also perform more sophisticated statistical analyses of two or more annotations or array processing parameters that may be involved in the separation of the classes of data. Some examples of such analyses include clustering analysis, principal component analysis and the like. Upon viewing the diagnosis output, the investigator can then evaluate the highest correlated array processing parameters /user annotations in more detail. The investigator may set up a query or sort based upon one or more of the highly correlated array processing parameters /user annotations and plot a chart 252 to see if the data separates between values within normal expectations and those that significantly differ from the normal expectations. If such a separation is successful, this confirms that the array processing parameters /user annotations sorted upon are likely the cause of the significant changes in global statistics values.

Diagnosis tool 150, when integrated with the feature extraction system, may run in batch mode to automatically identify and diagnose problems potential problems that may impact extraction data analysis. In addition or alternative to identifying correlations between array processing parameters/user annotations and significantly changed global statistic values, diagnosis tool 150 may be provided with a set of diagnostic rules 152 (rule set) that may be stored locally or accessed from retrospective database 100, for example (or FE database 10, when diagnosis tool 150 is integrated with the feature extraction system). With the use of the rules 152 provided in rule set, diagnosis tool may identify problems or potential problems with the global statistics resulting from feature extractions. In embodiments where diagnosis tool 150 is linked with or integrated in the feature extraction system, diagnosis tool 150 may also analyze feature data to identify problems or potential problems therein.

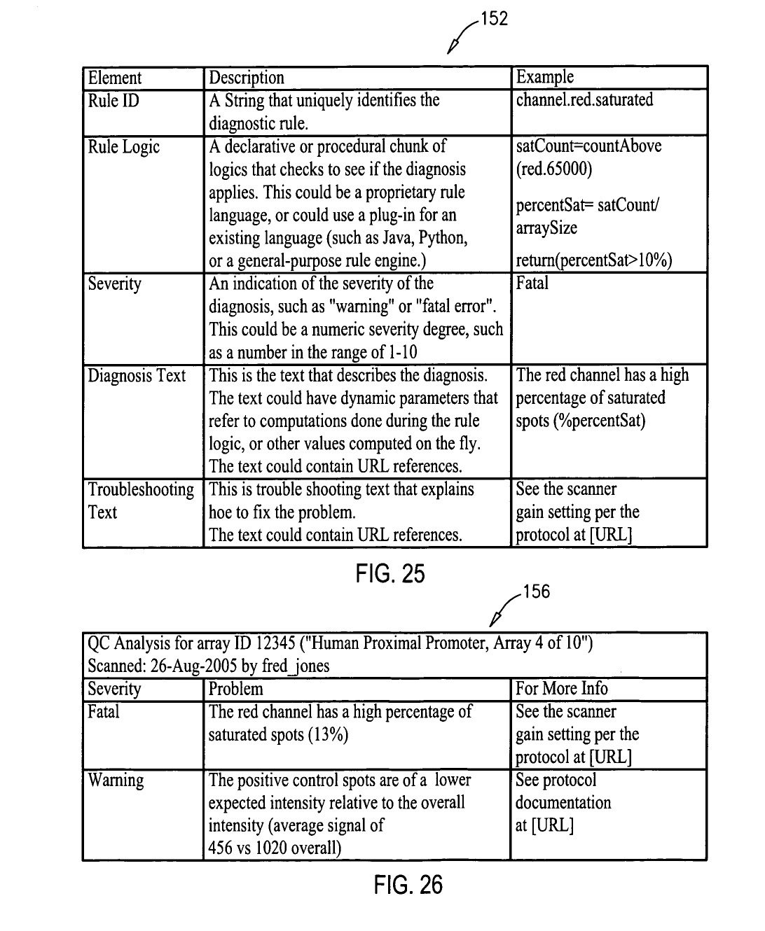

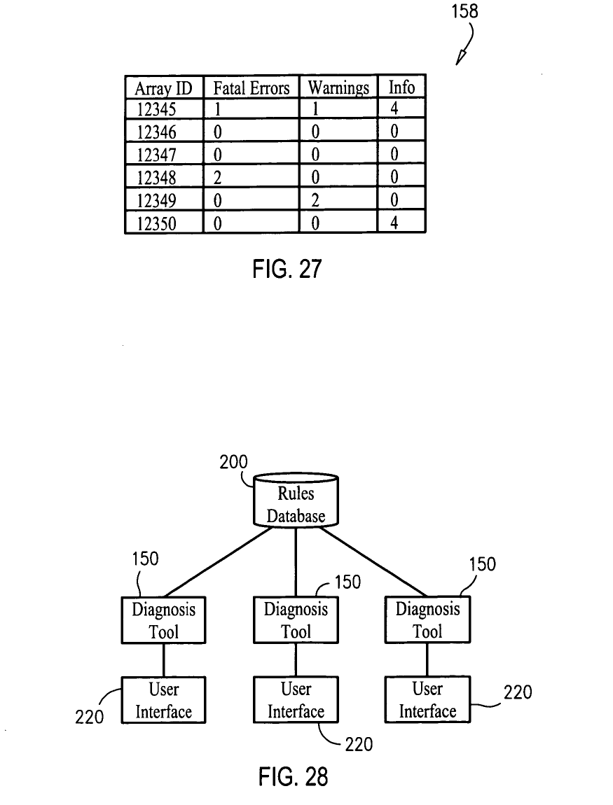

Each diagnostic rule contains a number of elements, that may include, but are not limited to the elements listed in the table shown in FIG. 25. A rule identifier (Rule ID) is characterized by a string that uniquely identifies the diagnostic rule and by which diagnosis tool 150 can access the rule. The rule logic includes comparative or procedural logic that diagnosis tool executes to check whether this rule applies to the data that is being analyzed. A severity element identifies the relative severity of the diagnosis that the rule determines if the rule logic determines that an problem or potential problem exists. Severity levels may include “warning” and “fatal error”, for example, as illustrated in the example in example report 156 in FIG. 26. The diagnosis text element describes the diagnosis and may have dynamic parameters that refer to computations done during execution of the rule logic, or other values computed on the fly. URL references may also be included in the diagnosis text element. The troubleshooting text element provides an explanation of how to fix the problem identified by the diagnosis. For batch processing, a batch summary of diagnostic results 158 (FIG. 27) may be outputted by the diagnostic tool 150. This summary 158 may be appended to the Bach Run Summary 60 outputted by the feature extraction system when diagnostic tool is integrated with or linked to the feature extraction system. Summary 158 may be appended to Report 40, QC charts 250 and/or Summary Plot 280 when diagnostic tool is integrated or linked with the retrospective system.

Examples of problems that may be diagnosed by diagnosis tool 150 using rules 152 include, but are not limited to: unusually high number of saturated features in red or green channel, unusually low overall intensity, unusually large number of features reported as not within limits of feature extraction thresholds, unusually large number of extractions having one or more global statistics not within limits of thresholds, excessive baseline noise, poor signal-to-noise ratio, unusually low number of enriched probes. Rules may be provided for analysis of expected intensity ranges and distributions of features (either control or non-control features) or local background regions (both inter-array and intra-array), analysis of expected distribution of features and image analysis of various scatter plots, distributions of number of flagged features or local background regions, etc., to check if the distributions have the expected shape. When analyzing an array set, set consistency may be checked against one or more rules. For example, an array set may be designed with one or more common features, that is the same feature or set of features is placed on each array in the set and may be placed at the same corresponding locations on each array. These common feature may be rule checked to determine whether comparable signals are received from the common features across arrays in the array set. Additionally, replicates of features are commonly used on arrays as well as array sets. Rule checking may be implemented to check whether one or more statistics of these features are comparable across replicates. Metrics may be provided that involve the analysis of two or more arrays simultaneously, e.g. to check common features and/or replicates.

As the number of rules 152 in a rule set increases, diagnosis tool 150 may cache intermediate values that are used among multiple calculations, such as during the diagnosis of a batch of extractions, for example. Diagnosis tool 150 may also pre-calculate commonly used values and make the pre-calculated values available as part of a standard interface/runtime for rules.

Diagnosis tool 150 implements a rule language (e.g., such as Python or other known rule language) which can be embedded for rules processing. For example, rules 152 may be stored in a simple text table or SML file, with each row or XML element corresponding to a rule 152. Each of the properties of the elements of a rule may be stored as column entries or XML sub-elements, in order to keep descriptions, messages and code for each rule together.

The rule set may be upgradeable without requiring an upgrade of the system software. For example, each client of the system may synchronize with a rules database to maintain a current and latest set of diagnostic rules 152. The rules database may be integrated with database 100 and/or database 10 in embodiments where diagnosis tool 150 is integrated with the retrospective system and/or the feature extraction system. FIG. 28 is a diagram of a central rules database (rules server) 200 that may be provided independently of databases 10 and 100 and which may be accessed by multiple diagnosis tools 150 (clients) which may be accessed by a user via user interface 220. Additionally, the system can support multiple rules servers. For example, server 200 may be a central server located at a remote site and an additional server may be deployed at a customer site to provide rules for all the clients/diagnosis tools 150 of the customer. When a new rule 152 becomes available or an existing rule 152 is changed, the system may be set up so that each client (diagnosis tool 150) automatically downloads and installs the new rule information. Such downloading or retrieval may be accomplished by Web services protocols (e.g., SOAP, HTTP, XML, etc.).The system may use proxy configuration form an existing Web browser on the client to configure client access through a corporate firewall.

The system may provide a method for users to control which rule updates get installed. Methods may include, but are not limited to: user display of available rule updates, from which the user would selected which rule updates, if any, to download; user option to block updating of rules generally or by specific rule; and/or user display of rule history, giving the user the option to revert back to a previous version of a set of rules 152.

The system may also implement an authentication mechanism whereby the client's software license key must be provided as part of a request for a rules update. Upon receiving a request, the system may check the key for validity, and deny the request if the key is invalid, or allow the rules update, but warn the user that the key is invalid or expired, or allow the update when the key is valid and generate a log entry on server 200 (or 100 or 10) to indicate that the client with the particular key associated with the request has been updated.

The system may support multiple rules servers. For example, a rules server may be implemented on a feature extraction system as well as on the retrospective system. Additionally, a rules server may be deployed at a user location, where the local rules server may augment or override the central rules server provided on the central rules server 200 (or 100 or 10).

Rules 152 may be provided that are specifically tailored to certain types of experiments, extractions, etc. For example, there may be rules that are specific to gene expression extractions, CGH extractions or ChIP-on-Chip extractions only. The system may automatically select which rules to run based on the type of experiment or extraction (analysis).

As noted, the rules may contain URL references. One or more of these URL references may point back to the Web page of the system owner, where users can download updates of the rules or get support information about a problem identified by a diagnosis rule.

The diagnosis tool may also be configured to discover new rules. For example, a user may perform an extraction query to identify a set of extractions that should perform similarly for one or more metrics. Next the user may identify which extractions in that set have a known problem, such as scanner needing calibration, or some other known problem. The diagnosis tool may then be used to scan available global statistics from the extractions having the known problem and perform statistical analyses, for example creating a decision tree that can be used for future identifications of the type(s) of known problems associated with the extractions that were analyzed.

Database Schema

Retrospective database 100 may be independent of FE database 10, or may be integrated therewith, as noted above. Retrospective database 100 may be incorporated into a storage device of a computer system such as a hard drive for example, whether integrated with FE database 10 or not. Alternatively, retrospective database 100 may be maintained separately from a user's computer system such as stored in a database on a server, for example. A main engine 50 is provided to run retrospective database 100 (see FIG. 3). Main engine 50 may also run on a user's computer system, or be provided on a server. In general retrospective tool 105 can be pointed to any database that has the appropriate schema running on it, to perform the functions described herein. One non-limiting example of a main engine 50 is SQLServer/MSSE® (Microsoft Corporation, Redmond Wash.). MSDE may be free to a user and is typically limited to a single user. In combination with SQLServer®, MSDE can operate retrospective database 100 for a plurality of users. SQLServer® also allows for bigger databases and provides additional GUI front end services to help manage databases. Main engine 50 runs continuously and operates as a service.

Underneath main engine 50 it is possible to set up multiple databases. Master database 52 is provided with main engine 50 and facilitates the administration of any additional databases that are added to the database system. Retrospective database 100 is one database that is added to this configuration for operation with the retrospective system. As noted, this may be a standalone configuration. Alternatively, FE database 10 may also be provided in the database schema such that both retrospective database 100 and FE database 10 are run by the main engine/database server 50, as indicated by FIG. 3, including the components shown in phantom. In this arrangement, FE database 10 and retrospective database 100 are distinct in that they have separate schema, but main engine (e.g., SQLServer®, or the like) provides the mechanisms for a user to cross-query database 10 and database 100. However, in general, the retrospective tool 105 can be pointed to any database set up with the appropriate schema to create, store and recall data, charts and metrics, etc.

As noted above, each record in a DataStore file stored in database 100 may include statistics, array processing parameters and user annotations for an extraction that is represented in that record. Creation of database 100 may be handled by QC chart tool 140. On first use of tool 140, it detects on the user's local computer whether schema or configuration information is available or not. If this is not available, then the user will have to provide database configuration information (e.g., SQLServer details (Server name\Instance name, database user credentials, database files path). This configuration is then saved in an .ini file (e.g., QCChartDBInfo.ini) and is stored in the directory where the tool application 140 is located.

To load the DataStore file in database 100 with records, a user may select to run retrospective tool 105 and point it to a directory that contains a text file of global statistics and array processing parameters for extractions (which may include a directory in FE database, or an external file or directory) of feature extractions output 22 (or feature extractions output may automatically be processed and loaded in embodiments of the system where the feature extraction system and retrospective system are integrated), at which time QC tool 140 recursively processes the directory, file or folder to extract the global statistics and array processing parameters for each extraction contained therein, and compose a record for each extraction. Since user annotations are not included in feature extraction outputs, the system provides for user annotations to be populated into the records subsequently.

For example, an Excel® (Microsoft Corporation, Redmond Wash.) or other text file may be provided which includes a unique identifier (e.g., barcode identifier or other unique identifier) in one column, for each extraction that user annotations are to be added to, with additional columns containing user annotation fields and under which specific values of those user annotations are inputted for specific extractions. The user annotation fields may be freely defined by the user. Some may already be pre-existing, such as, for example, when DataStore file already contains extraction records that have user annotations associated with them, but either way, the user can freely define any user annotation fields that the user desires to associate with one or more extraction records and store them in DataStore file.

QC Chart tool may be pointed to a file containing user annotations as described above, to load the user annotations into the appropriate extraction records as identified by the unique identifiers. One of the array processing parameters in the extraction records contains the unique identifiers of the extractions. For example, when the barcode labels of the arrays are used as unique identifiers, one of the fields in the array processing parameters stored in the extraction records stores the barcode identifier of the extraction for each record. Accordingly, QC chart tool 120 recursively selects the unique identifiers in the file containing the user annotations and searches for that unique identifier in the DataStore file. When a match is found, the user annotations associated with that unique identifier are concatenated to the record in DataStore file having the same unique identifier. This process is continued until all of the unique identifiers in the file containing the user annotations have been selected by QC chart tool and searched for in DataStore file and all concatenations have been accomplished.

A database schema typically has a table format with columns and one of those columns defines the data type of the data entered into a particular row of the table. These columns, once defined are typically fixed. The database server software (e.g. SQLServer® or the like) may allow a limited number of additional columns to be added to a table, but this feature is quite limited, as there is a finite number of columns that can be added and this number is quite limited. Also, columns that are added by this technique tend to become fragmented from the main table when stored on a storage disk, so that search times become significantly slower. The database schema of retrospective database 100 is designed to be fully and freely extensible. Thus, there is no need to predefine columns for the types of different user annotations that are to be added to the extraction records. Since user annotations can vary widely, the system permits new user annotation fields to be added at any time, and a user can add as many new and different annotation fields as desired.

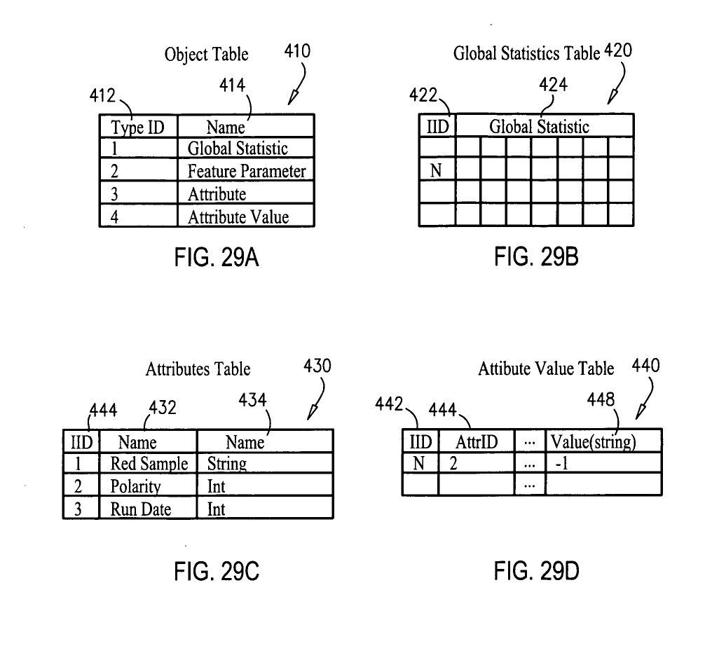

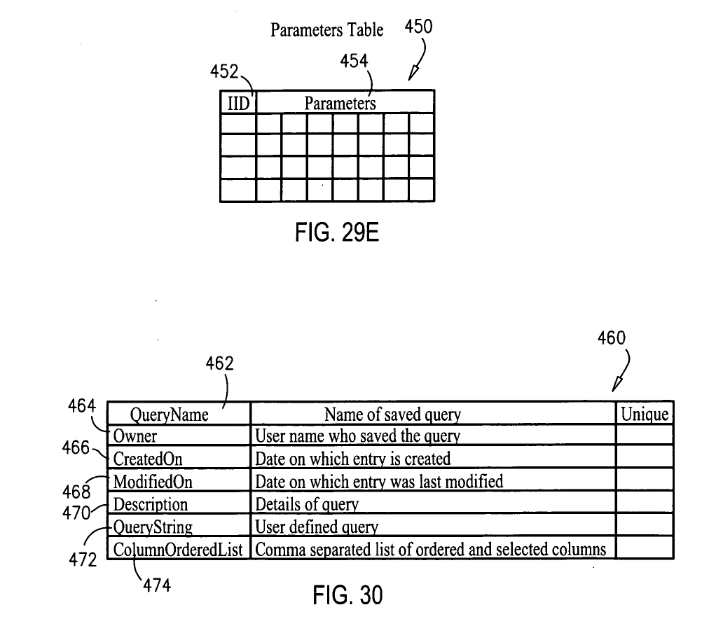

To establish the fully extensible schema, a plurality of cross-referencing tables are established. FIG. 29A illustrates an object table which includes a column that contains type identifiers (Type ID) 412 and names 414 of objects. For example, the object table 410 illustrated included four type ID's for four different objects (e.g., “global statistic” is assigned a Type ID of “1”, etc.) A global statistics table 420 (illustrated in FIG. 29B) includes one column 422 for instance identifiers (IID's, which are effectively record numbers) and typically has multiple columns 424 of global statistics of the types described above, that are global metrics for an extraction reported on in a row of the table.

An attribute table 430 is illustrated in FIG. 29C. Attribute table 430 includes a column that identifies the name 432 of the attribute and a column that identifies the attribute type 434. FIG. 29C illustrates a record in the attribute table 430 for an attribute named “Red Sample” which is a “string” data type. Attribute table 430 further includes a column for attribute identifier (Attr ID) 444 (Red Sample record has Attr ID of “1” as illustrated).

Attribute value table 440 includes a column 442 for IID's, and a column 444 for attribute identifiers. Attribute identifiers identify the name of the attribute. A named attribute can have many different values. Each different value is associated with a different IID (instance identifier). Attribute value table 440 further includes a column 448 for a value, which is a string that identifies the value of the attribute reported on that row. The attribute ID points to the attributes table 430 and the IID points to the global statistics table 420.

To compose a record to be stored in DataStore file, retrospective tool 105 can query the IID values recursively in global statistics table 420 to identify values from the other tables that are linked to that IID value. Each IID will have other values associated with it, including those described above. One such value may be a bar code identifier or other identifier that is unique to a particular extraction. The barcode identifier or other unique identifier identifies a particular extraction in database 100. Note that if a user scanned the same array more than once or extracted the same array more than once, then a barcode identifier will not be unique to only one extraction, and some other unique identifier may be assigned to the various extractions having the same barcode identifier. Alternatively, an extraction query that includes such a barcode identifier will return multiple IIDs for that barcode identifier, which the user would then need to review and select one or more of the extractions that are associated with that barcode identifier. Further alternatively, the retrospective system may be configured to prevent more than one extraction with the same barcode identifier to be stored in database 100. FIG. 29D shows an example of one such record. Note that there may be many records in attribute values table having the same IID which are linked to different attributes (e.g., as many user annotations as there are to be added to that record), but that each of these will have a unique Attr ID. Following the example in FIG. 29D, when the record shown is identified, tool 105 refers to AttrID 444 to locate the AttrID value of 2. By referencing attributes table 430 for the IID of 2, tool receives the name of the attribute (in this case, “polarity”) and the type (in this case, “integer” (Int)). The value of this polarity attribute is given in column 448 of attributes value table 440 as “−1”. FIG. 29E illustrate a parameters table 450 that is organized similarly to the global statistics table 420, such that the IID column 452 contains the unique identifies (such as barcode label identifier or other unique identifiers) for the extractions, and columns 454 contain the array processing parameters for the extractions. A record or row of array processing parameters may be selected by matching the IID 422 from global statistics table 420 with the IID 452 in parameters table 450.

Indexes are built using the various identifiers that are linked among the tables (e.g., IID's , AttrID's) and then searches can be performed using a clustered index so that searches may be performed much more quickly than having to go through and point to each table to match up identifiers each time. A clustered index attempts to keep the data in a record physically close to the clustered index on a storage medium on which the clustered index and data are stored. In the example referred to above, all of the data having an IID of “N” associated therewith will be attempted to be stored in the same block of memory and will be so stored if space in the block is permitting. If a block becomes filled, a consecutive block stores the overflow.

For allowing queries to be saved, the schema provides a table 460 (see FIG. 30) that stores the name of the query being save (i.e., “QueryName” 462, which may be named by the user storing the query. Each query record stored may also include a field for the name of the owner 464 that created the query, the date on which the query was created 466, the date on which the query was last modified 468, if applicable, a description of the query 470, the query string (user defined query) 472 used to perform the query and/or a column ordered list 474 which is a comma-separated list of ordered and selected columns. The stored query record stores the text of the query. This text can be read out and used as an extraction query against the database 100. As described above, an extraction query may fetch statistics, parameters, user annotations and attribute values, along with attribute names.

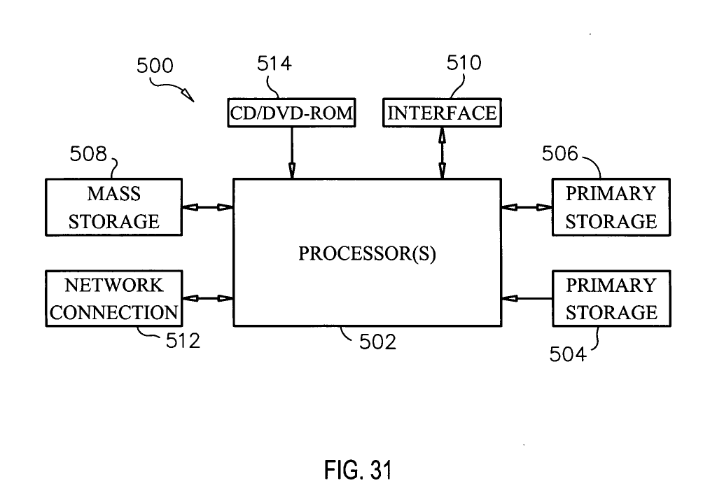

FIG. 31 is a schematic illustration of a typical computer system that may be used to perform procedures described above. The computer system 500 includes any number of processors 502 (also referred to as central processing units, or CPUs) that can run retrospective tool, statistic tool and QC chart tool applications for example. Processor(s) 502 are coupled to storage devices including primary storage 506 (typically a random access memory, or RAM), primary storage 504 (typically a read only memory, or ROM). As is well known in the art, primary storage 504 acts to transfer data and instructions uni-directionally to the CPU and primary storage 506 is used typically to transfer data and instructions in a bi-directional manner Both of these primary storage devices may include any suitable computer-readable media such as those described above. A mass storage device 508 is also coupled bi-directionally to CPU 502 and provides additional data storage capacity and may include any of the computer-readable media described above. Mass storage device 508 may be used to store programs, data and the like and is typically a secondary storage medium such as a hard disk that is slower than primary storage. Databases described herein may be stored on mass storage device(s) 508. It will be appreciated that the information retained within the mass storage device 508, may, in appropriate cases, be incorporated in standard fashion as part of primary storage 506 as virtual memory. A specific mass storage device such as a CD-ROM or DVD-ROM 514 may also pass data uni-directionally to the CPU.

CPU 502 is also coupled to an interface 510 that includes one or more input/output devices such as such as video monitors, track balls, mice, keyboards, microphones, touch-sensitive displays, transducer card readers, magnetic or paper tape readers, tablets, styluses, voice or handwriting recognizers, and/or user interface 120 described herein, or other well-known input devices such as, of course, other computers. Finally, CPU 502 optionally may be coupled to a computer or telecommunications network using a network connection as shown generally at 512. With such a network connection, it is contemplated that the CPU might receive information from the network, or might output information to the network in the course of performing the above-described method steps. For example, one or more of the databases described herein may be provided on a server that is accessible by processor 502 over network connection 512. The above-described devices and materials will be familiar to those of skill in the computer hardware and software arts.

The hardware elements described above may implement the instructions of multiple software modules for performing the operations of this invention. For example, instructions for stripping global statistics and array processing parameters from feature extraction outputs may be stored on mass storage device 508 or 514 and executed on processor 502 in conjunction with primary memory 506.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method of facilitating analysis of feature extraction outputs across multiple extractions, said method comprising:
inputting a feature extraction output of an extraction resulting from feature extraction of an array;
extracting global statistics and array processing parameters from the feature extraction output;
populating a table or file with the extracted global statistics and array processing parameters of the extraction; and
repeating said inputting, extracting and populating for at least one additional feature extraction output of another extraction, so that said table or file includes global statistics that can be readily cross-compared over multiple extractions with reference to a single table or file.

2. The method of claim 1, further comprising displaying the table on a user interface for comparisons of global statistics by a user.

3. The method of claim 1, further comprising plotting a chart of metric values for a metric in said table or file for a plurality of extractions, and displaying the chart on a user interface.

4. The method of claim 3, further comprising displaying a threshold value on the chart.

5. The method of claim 4, further comprising highlighting metric values that exceed the threshold value on the chart or highlighting metric values that are within limits of the threshold value.

6. The method of claim 3, wherein said metric values in said chart are dynamically linked to said table or file, and wherein clicking on a metric value in the displayed chart causes said table to be displayed so that a user can review all metric values for all metrics for the extraction from which the metric value clicked on was plotted.

7. The method of claim 1, wherein said inputting is directed manually by a user through a user interface.

8. The method of claim 1, wherein said inputting is performed automatically by integration with a feature extraction system.

9. The method of claim 1, further comprising storing the file in a database, and wherein subsequent executions of the method of claim 1 add the subsequent global statistics and array processing parameters of the subsequent extractions to the stored file, so that global statistics and array processing parameters of all extractions are stored in the file.

10. The method of claim 1, further comprising appending a user annotation to the array processing parameters and global statistics of an extraction in said file or table.

11. The method of claim 10, further comprising plotting a chart of metric values from at least one of the user annotations in said table or file for a plurality of extractions, and displaying the chart on a user interface.

12. The method of claim 10, wherein user annotation columns in said table can be created for any user annotation by a user through a user interface.

13. The method of claim 9, further comprising querying the file in the database to select a subset of the extractions for further processing.

14. The method of claim 13, further comprising querying the file in the database to select a subset of the extractions for further processing, wherein a query may include any metric field for which a particular global statistic is provided, user annotation field, array processing parameter field, specific extraction identification number, specific user annotation, specific array processing parameter, specific global statistic value, or any non-contradictory combination of these.

15. The method of claim 13, further comprising:
selecting a metric for which global statistics are reported in the subset of the extractions;
plotting a chart of the metric values from the global statistic values in the subset of extractions reported for the metric;
calculating summary statistics characterizing the distribution of the plotted metric values; and
setting a threshold value for the distribution.

16. The method of claim 13, further comprising:
selecting a metric for which a user annotation is reported in the subset of the extractions;
plotting a chart of the metric values from the user annotation values in the subset of extractions reported for the metric;
calculating summary statistics characterizing the distribution of the plotted metric values; and
setting a threshold value for the distribution.

17. The method of claim 15, wherein the threshold value is set based on at least one of the calculated summary statistics.

18. The method of claim 13, further comprising grouping or ordering the extractions in the subset by sorting the subset or re-querying the file in the database.

19. The method of claim 3 performed a plurality of times for a plurality of different metrics, wherein charts resulting therefrom are displayed in a vertical stacked formation in a QC chart.

20. The method of claim 13, further comprising saving the query in the database, wherein the query can be called later for re-use.

21. A method of facilitating analysis of feature extraction outputs across multiple extractions, said method comprising:
querying a file containing global statistics and array processing parameters for each of a plurality of extractions to select a subset of records, each record containing global statistics and array processing parameters for a different extraction;
selecting a metric for which global statistics are reported in the subset of the extractions;
plotting a chart of the metric values from the global statistic values in the subset of extractions reported for the metric;
calculating summary statistics characterizing the distribution of the plotted metric values; and
setting a threshold value for the distribution.

22. The method of claim 21, wherein the threshold value is set based on at least one of the calculated summary statistics.

23. The method of claim 22, wherein the threshold value setting is selected by a user.

24. The method of claim 21, wherein the threshold value is inputted manually by a user after viewing the chart.

25. The method of claim 21, further comprising repeating a least the selecting, plotting, calculating and setting steps of claim 19 for at least one other metric.

26. The method of claim 25, further comprising defining an evaluation metric by a user, based on the thresholds that were set.

27. The method of claim 26, further comprising storing the metrics, thresholds, evaluation metric and extraction query used to obtain the extraction sets from which the metrics were selected, in the database as a metric set.

28. The method of claim 27, wherein each query stored is date-stamped with a date on which the query was performed.

29. The method of claim 27, further comprising comparing thresholds in said metric set against the global statistics provided in another set of extractions for the same metrics, and evaluating the quality of the arrays from which the extractions in said another set were produced, based on said evaluation metric.

30. The method of claim 29, wherein said comparison is performed automatically.

31. The method of claim 30, wherein said automatic comparison is done on the fly upon receiving feature extractions outputs from an integrated feature extraction system.

32. The method of claim 30, wherein said automatic comparison is done on the fly by a feature extraction tool in a feature extraction system, said metric set having been imported into said feature extraction system.

33. A set of reports for facilitating analysis of feature extraction outputs across multiple extractions, said set comprising:
a statistics table containing global statistics for metrics, array processing parameters and user annotations for multiple extractions, each row of said table containing data for a single extraction, said data including at least global statistics and an array processing parameter, including a unique identifier for the extraction, wherein said table contains data for at least two different extractions; and
a QC chart displaying at least one plot of a metric values from global statistics for the metric across a plurality of said extractions.

34. The set of claim 34, wherein said QC chart and said statistics table are dynamically linked.

35. The set of claim 33, further comprising a summary plot that graphically illustrates evaluation results of metric values plotted in said QC chart for at least one metric, each over a plurality of extractions.

36. The set of claim 35, wherein said summary plot is dynamically linked with said QC chart.

37. A retrospective system for facilitating analysis of feature extraction outputs across multiple extractions, said system comprising:
a processor; and
a retrospective tool programmed to receive an input of a feature extraction output of an extraction resulting from feature extraction of an array, extract global statistics and array processing parameters from the feature extraction output, and populate a table or file with the extracted global statistics and array processing parameters of the extraction.

38. The retrospective system of claim 37, further comprising a database, wherein the file containing global statistics and array processing parameters is stored in said database.

39. The retrospective system of claim 37, further comprising a user interface, said system configured to display said table on said user interface.

40. The retrospective system of claim 39, wherein said retrospective tool is further programmed to plot at least one metric for which global statistics are contained in said table or file against a plurality of said extractions.

41. The retrospective system of claim 38, further comprising a user interface, said user interface being configured for user querying of said database to select a subset of the extractions and associated data contained in said file.

42. The retrospective system of claim 37 integrated into a feature extraction system.

43. The retrospective system of claim 41, wherein said retrospective tool is further programmed to plot at least one metric, selected by a user through said user interface, for which global statistics are contained in said table or file against the subset of extractions returned by said query.

44. The retrospective system of claim 43, wherein said user interface is configured for interactive user setting of a threshold value for a distribution of metric values from said global statistics plotted for the selected metric.

45. The retrospective system of claim 44, wherein said user interface is further configured for interactive user setting of an evaluation metric based on a plurality of thresholds set for a plurality of metrics.

46. The retrospective system of claim 42, wherein a plurality said inputs of feature extraction outputs from a plurality of extractions having been batch processed by the feature extraction system are received and processed automatically by said retrospective tool.

47. The retrospective system of claim 46, wherein said retrospective tool further automatically plots at least one metric for which global statistics are contained in said table or file against the batch of extractions received from the feature extraction system.

48. The retrospective system of claim 37, wherein said retrospective tool is configured to automatically compare thresholds stored in a metric set against the global statistics provided in a set of extractions received, in regard to the same metrics, and evaluate the quality of the arrays from which the extractions received were produced.

49. The retrospective system of claim 48, wherein said system automatically evaluates a quality of an extraction as acceptable or a status of hold for further evaluation, based upon an evaluation metric.

50. The retrospective system of claim 49, further comprising a database, wherein the system stores the quality evaluation results of the extractions in associations with the global statistics and array processing parameters for those extractions.

51. The retrospective system of claim 50, wherein the system calculates a statistic for a metric using the quality evaluation results of the extractions being analyzed against the metric.

52. The retrospective system of claim 49, wherein said system automatically transmits data from extractions evaluated as acceptable, to another system for further processing, and wherein extractions evaluated as hold for further evaluation are prevented from being sent until being reviewed further and manually approved.

53. A feature extraction system for facilitating analysis of feature extraction outputs across multiple extractions, said system comprising:
a processor; and
a feature extraction tool programmed to extract global statistics and array processing parameters from a batch of feature extraction outputs produced by the feature extraction system, and populate a table or file on the fly with the extracted global statistics and array processing parameters extracted from the batch of feature extraction outputs.

54. A diagnostic tool for identifying and diagnosing potential problems in feature extraction outputs, said tool comprising:
a processor;
a set of diagnostic rules;
a rules software language executable by said processor to execute said rules against at least one of feature extraction global statistics and feature extraction data, to determine whether logic provided in a rule is met or violated by the global statistic data value or feature data value compared; and
programming for outputting potential problems identified by executing said rules against the at least one data value.

55. The tool of claim 54, wherein each rule in said rule set comprises a rule identifier, rule logic, severity element, diagnosis text and troubleshooting text.

56. The tool of claim 54, wherein said rule set is extensible, said rule set being configured to add, remove or modify rules.

57. The tool of claim 54 configured to update said rule said by downloading information over a network.

58. The tool of claim 54, wherein said tool further outputs at least one of a diagnosis for correction of a potential problem, and instructions where further information can be obtained to solve the potential problem.

59. The tool of claim 54 integrated into a retrospective system.

60. The tool of claim 54 integrated into a feature extraction system.

61. The tool of claim 54, further comprising a database in which said set of diagnostic rules are stored.

62. The retrospective system of claim 37, further comprising:
a diagnostic tool including a set of diagnostic rules, a rules software language executable to execute said rules against at least one of feature extraction global statistics and feature extraction data, to determine whether logic provided in a rule is met or violated by the global statistic or feature data value compared, and programming for outputting potential problems identified by executing said rules against the data value.

63. The retrospective system of claim 62, wherein said diagnostic tool is configured to discover new rules by performing at least one of clustering and creating a decision tree based on at least one of available global statistics, array processing features and user annotations.

64. A method of evaluating the quality of feature extraction outputs from a plurality of arrays expected to produce the same results, said method comprising:
inputting feature extraction outputs of the extractions resulting from feature extraction of the arrays;
extracting global statistics and array processing parameters from the feature extraction outputs;
populating a table or file with the extracted global statistics and array processing parameters of the extractions;
plotting at least one metric against the global statistics reported for that metric for the extractions; and
analyzing the at least one plot to identify potential outliers.

65. A method of correlating a change in an array processing parameter for an extraction with changes in feature extraction outputs, said method comprising:
inputting feature extraction outputs of extractions resulting from feature extraction of arrays having a first set of array processing parameters;
extracting global statistics and array processing parameters from the feature extraction outputs;
inputting feature extraction outputs of extractions resulting from feature extraction of arrays having a second set of array processing parameters, wherein the second set is the same as the first set except for a change in one or a small percentage of the array processing parameters;
extracting global statistics and array processing parameters from the feature extraction outputs from the arrays having the second set of array processing parameters;
populating a table or file with all extracted global statistics and array processing parameters of the extractions;
plotting at least one metric against the global statistics reported for that metric for the extractions; and
comparing the values in the at least one plot to establish whether there is a significant difference between values from the arrays having the first set of array processing parameters versus values from the arrays having the second set of array processing parameters.

66. A method of developing a microarray product, said method comprising:
inputting feature extraction output of an extraction resulting from feature extraction of an existing array;
extracting global statistics and array processing parameters from the feature extraction output;
inputting feature extraction output of an extraction resulting from feature extraction of an array similar to the existing array, but in which at least one factor was changed;
extracting global statistics and array processing parameters from the feature extraction output from the array similar to the existing array;
populating a table or file with all extracted global statistics and array processing parameters of the extractions;
plotting at least one metric against the global statistics reported for that metric for the extractions; and
comparing the values in the at least one plot to establish whether the change of at least one factor had a positive, negative, or no impact on the feature extraction output as measured by the at least one metric.

67. The method of claim 66, wherein said factor comprises at least one of a change in hybridization conditions used to prepare the array, a change in scanner used to scan the array, a change in an array processing parameter, a change of at least one extraction algorithm used to perform the feature extraction, a change in a printer used to print the array, a change in a reagent used during processing of the array, and a change in a version of feature extraction software used to perform the extraction.

68. A method of diagnosis of potential errors in feature extraction outputs, said method comprising:
inputting a feature extraction output of an extraction resulting from feature extraction of an array;
extracting global statistics and array processing parameters from the feature extraction output;
populating a table or file with the extracted global statistics and array processing parameters of the extraction; and
repeating said inputting, extracting and populating for at least one additional feature extraction output of another extraction, so that said table or file includes global statistics that can be readily cross-compared over multiple extractions with reference to a single table or file;
plotting a chart of global statistic values for a metric in said table or file for a plurality of extractions;
evaluating the values in the chart to identify potential outliers; and
correlating one or more array processing parameters that are different between two sets of the global statistic values, one set predominantly containing the potential outliers and the other set containing predominantly non-outlier values; and identifying the one or more array processing parameters as possibly causative of the potential errors.

69. The method of claim 68, further comprising appending a user annotation to a record in said file containing an extraction and associated global statistics and array processing parameters, wherein said correlating may further comprise correlating one or more user annotations that are different between the two sets of the global statistic values, and identifying the one or more user annotations as possibly causative of the potential errors.

70. A method of diagnosis of potential errors in feature extraction outputs, said method comprising:
executing a set of diagnostic rules against a global statistic or feature data value to determine whether the value complies with logic contained with the set of rules; and
outputting a warning and diagnosis of a potential error for an extraction when a rule is found to have been violated by not complying with the logic contained in a rule.

71. The method of claim 70, wherein each diagnostic rule in said rule set comprises a rule identifier, rule logic, severity element, diagnosis text and troubleshooting text.

72. The method of claim 70, wherein said executing a set of diagnostic rules comprises executing a set of diagnostic rules against feature data values from a plurality of replicate features to determine correlation among the feature data values.

73. The method of claim 70, wherein said executing a set of diagnostic rules comprises executing a set of diagnostic rules against feature data values from a set of common feature across a plurality of arrays in an array set to determine correlation among the feature data values.

74. A computer readable medium carrying one or more sequences of instructions for facilitating analysis of feature extraction outputs across multiple extractions, wherein execution of one or more sequences of instructions by one or more processors causes the one or more processors to perform the steps of:
inputting a feature extraction output of an extraction resulting from feature extraction of an array;
extracting global statistics and array processing parameters from the feature extraction output;
populating a table or file with the extracted global statistics and array processing parameters of the extraction; and
repeating said inputting, extracting and populating for at least one additional feature extraction output of another extraction, so that said table or file includes global statistics that can be readily cross-compared over multiple extractions with reference to a single table or file.

75. A computer readable medium carrying one or more sequences of instructions for facilitating analysis of feature extraction outputs across multiple extractions, wherein execution of one or more sequences of instructions by one or more processors causes the one or more processors to perform the steps of:
querying a file containing global statistics and array processing parameters for each of a plurality of extractions to select a subset of records, each record containing global statistics and array processing parameters for a different extraction;
selecting a metric for which global statistics are reported in the subset of the extractions;
plotting a chart of the metric values from global statistic values in the subset of extractions reported for the metric;
calculating statistics characterizing the distribution of the plotted metric values; and
setting a threshold value for the distribution.

76. The computer readable medium of claim 75, wherein the following further steps are performed: repeating a least the selecting, plotting, calculating and setting steps for at least one other metric.

77. The computer readable medium of claim 75, wherein the following further step is performed: defining an evaluation metric interactively by a user, based on the thresholds that were set.

78. The computer readable medium of claim 77, wherein the following further steps is performed: storing the metrics, thresholds, evaluation metric and queries used to obtain the extraction sets from which the metrics were selected, in the database as a metric set.

79. The computer readable medium of claim 77, wherein the following further step is performed: comparing thresholds in said metric set against the global statistics provided in another set of extractions for the same metrics, and evaluating the quality of the arrays from which the extractions in said another set were produced, based on said evaluation metric.
